(19) United States
(12) Patent Application Publication
(10) Pub. No.: US 2009/0006659 A1
(43) Pub. Date: Jan. 1, 2009

(54) Advanced mezzanine card for digital network data inspection

(76) Inventors: Jack M. Collins, Fenton, MO (US); Charles M. Kastner, Crestwood, MO (US); Matthew P. Kulig, Millstadt, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/214,590

(22) Filed: Jun. 20, 2008

Related U.S. Application Data
(63) Continuation-in-part of application No. 10/037,593, filed on Oct. 19, 2001.
Application No. 10/037,593 is a continuation-in-part of application No. 12/004,791, filed on Dec. 21, 2007.
(60) Provisional application No. 60/937,864, filed on Jun. 29, 2007.

(51) Int. Cl. G06F 3/00

(52) U.S. Cl. 710/8

(57) ABSTRACT

Telecommunications computing apparatus and methods for performing deep packet inspection and other processing of data packets traversing high speed digital networks (15) such as the Internet. An apparatus embodiment of the present invention comprises a reconfigurable logic device (10); coupled to the reconfigurable logic device (10), means (11) for coupling the reconfigurable logic device (10) to an external digital network (15); and coupled to the reconfigurable logic device (10), an interface (16-19) for coupling the reconfigurable logic device (10) to at least one peripheral device (8) that is not part of said external digital network (15).

### RELATED APPLICATIONS

The present patent application claims the benefit of commonly owned U.S. provisional patent application 60/937,864 filed Jun. 29, 2007, entitled “Apparatus for High Speed Deep Packet Inspection and Classification of IP Based Network Traffic”; the present patent application is also a continuation-in-part (CIP) of and claims priority upon commonly owned U.S. patent application Ser. No. 10/037,593 filed Oct. 19, 2001, entitled “System and Method for Controlling Transmission of Data Packets Over an Information Network”; and the present patent application is also a continuation-in-part (CIP) of and claims priority upon commonly owned U.S. patent application Ser. No. 12/004,791 filed Dec. 21, 2007, entitled “TCP Data Reassembly”; all three of these prior patent applications are hereby incorporated by reference in their entireties into the present patent application.

### TECHNICAL FIELD

This invention pertains to the field of inspecting digital network data using application-specific and reconfigurable hardware elements that comply with the AdvancedMC Standard.

### BACKGROUND ART

Due to the increased speeds and volume of network traffic, the increase of malicious and nefarious data packets, and the illegal activities of pirated content, new methods are required to address these types of concerns. What is needed is a set of reconfigurable hardware elements for inspecting data packets that travel over high speed networks, such as the Internet, at line speed. The present invention addresses this need, while complying with the latest AdvancedMC Standard for printed circuit boards. As used in this specification including claims, “AdvancedMC Standard” is that standard described in AdvancedMC™, PICMG® AMC.0 R2.0 Short Form Specification, Dec. 28, 2006, which document is hereby incorporated by reference in its entirety into the present patent application, and related documents and standards, including AMC.0, AMC.1, AMC.2, AMC.3, and AMC.4, as described at http://www.picmg.org/v2internal/specifications.htm. These standards are promulgated by PICMG (PCI (Peripheral Component Interconnect) Industrial Computer Manufacturers Group), a consortium of over 450 companies that collaboratively develop open specifications for high performance telecommunications and industrial computing applications. The present invention also complies with relevant portions of the PICMG standards for Advanced Telecommunications Computing Architecture (ACTA) and MicroTCA.

### DISCLOSURE OF INVENTION

Telecommunications computing apparatus and methods for performing deep packet inspection and other processing of data packets traversing high speed digital networks (15) such as the Internet. An apparatus embodiment of the present invention comprises a reconfigurable logic device (10); coupled to the reconfigurable logic device (10), means (11) for coupling the reconfigurable logic device (10) to an external digital network (15); and coupled to the reconfigurable logic device (10), an interface (16-19) for coupling the reconfigurable logic device (10) to at least one peripheral device (8) that is not part of said external digital network (15).

### BRIEF DESCRIPTION OF THE DRAWINGS

These and other more detailed and specific objects and features of the present invention are more fully disclosed in the following specification, reference being had to the accompanying drawings, in which:

FIG. 1 is a system level block diagram of an AMC board 1 consistent with the tenets of the present invention.

FIG. 2 is a drawing showing input/output banks associated with an FPGA 10 suitable for use in the present invention.

FIG. 3 is a drawing showing input/output banks associated with an FPGA 16 suitable for use in the present invention.

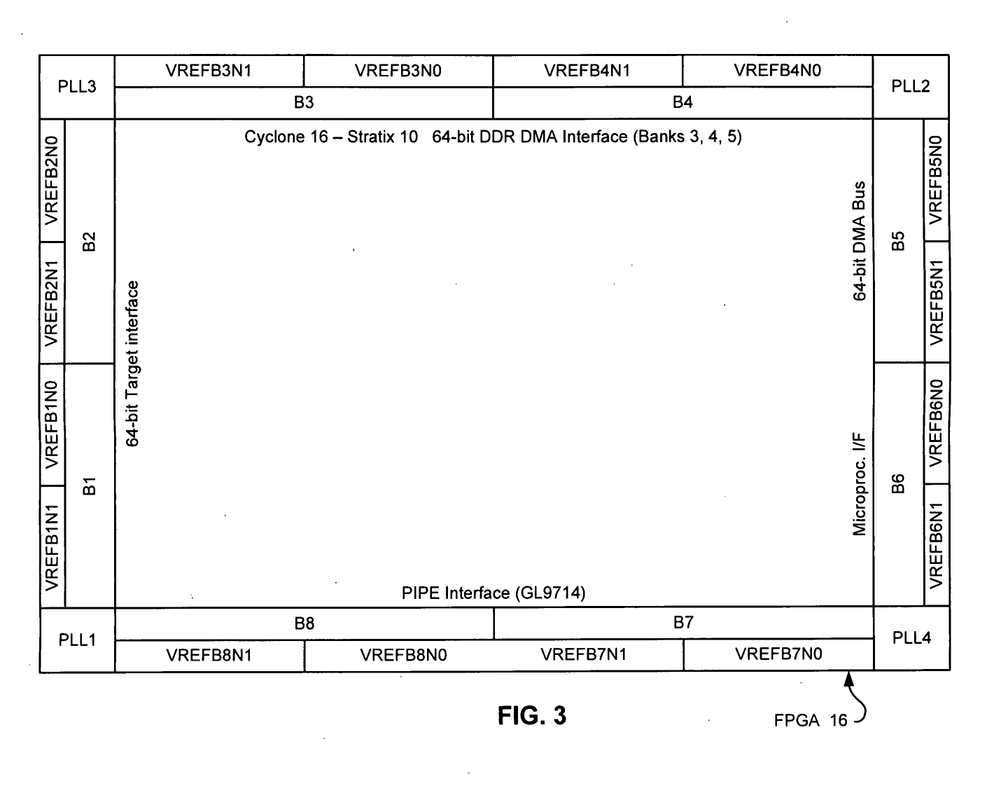

FIG. 4 is a drawing illustrating the clocking of FPGA 16.

FIG. 5 is a block diagram illustrating means for reconfiguring FPGA's 10 and 16.

FIG. 6 is a block diagram illustrating microcontroller 9.

FIG. 7 is a block diagram illustrating a JTAG chain.

FIG. 8 is a block diagram of a power supply suitable for powering board 1.

### DETAILED DESCRIPTION OF THE PREFERRED EMBODIMENTS

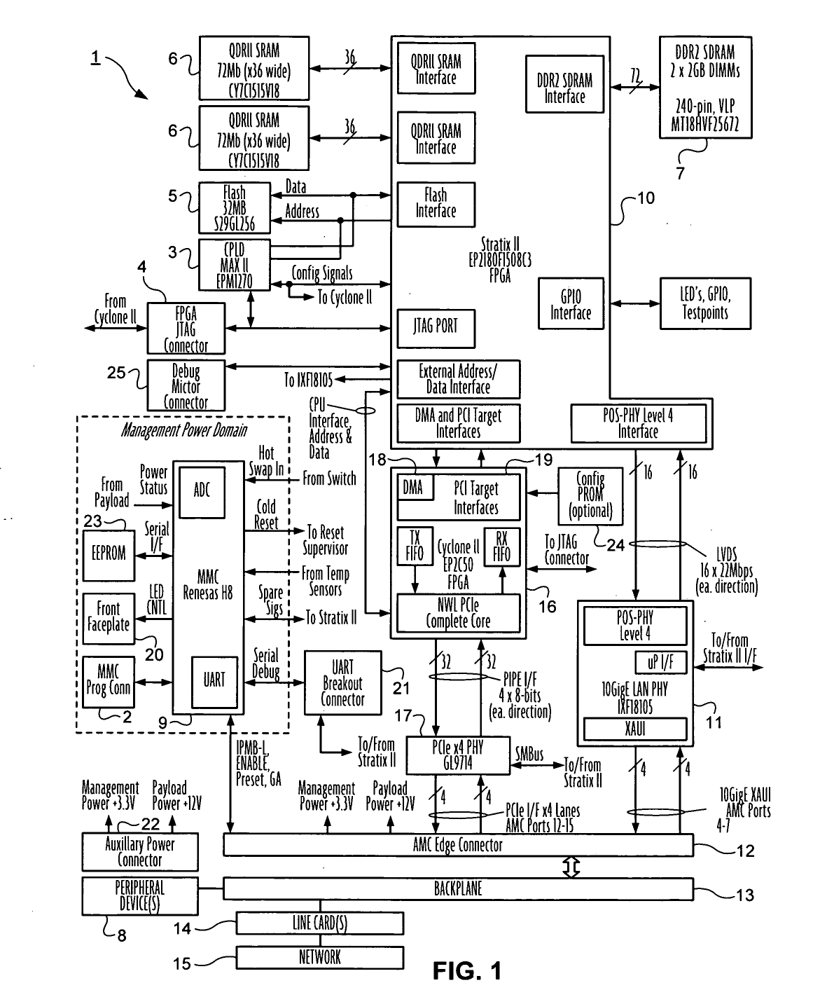

In a preferred embodiment, illustrated in FIG. 1, the present invention is a telecommunications computing apparatus 1 comprising a reconfigurable logic device 10; coupled to the reconfigurable logic device 10, means 11 for coupling the reconfigurable logic device 10 to an external digital network 15; and coupled to the reconfigurable logic device 10, an interface 16-19 for coupling the reconfigurable logic device 10 to at least one peripheral device 8 that is not part of said external digital network 15. While peripheral devices 8 are not part of said external digital network 15, they may be indirectly coupled thereto.

In a preferred embodiment, the reconfigurable logic device 10 comprises an FPGA (field programmable gate array), and the interface 16-19 comprises at least one component from the group of components consisting of at least one PCI Express connection 17 and at least one FPGA 16. Each FPGA 16 comprises at least one DMA (Direct Memory Access) component 18 and at least one PCI target interface component 19.

In a preferred embodiment, the coupling means 11 comprises a physical coupling device 11 connected to the reconfigurable logic device 10; an edge connector 12 connected to the physical coupling device 11; a backplane 13 connected to the edge connector 12; and at least one line card 14 connected to the backplane 13 and to the external digital network 15.

Each peripheral device 8 is also preferably connected to the backplane 13.

Preferably and advantageously (for reasons of speed), the apparatus elements illustrated in FIG. 1 consist solely of application-specific and reconfigurable hardware elements.

The reconfigurable logic device 10 illustrated herein is capable of performing many functions; for example:
Reassembly of TCP data emanating from the external digital network 15 by solely hardware means.
Search for known patterns within the reassembled TCP data.
Policy management decisions made with respect to patterns found within the reassembled TCP data.
Deep packet inspection on data packets emanating from the external digital network 15. By deep packet inspection is meant inspection and processing of data packets at layers 2 through 7 of the Open Systems Interconnect (OSI) model of the International Standards Organization (ISO). Layer 2 is the data link layer, layer 3 is the network layer, layer 4 is the transport layer, layer 5 is the session layer, layer 6 is the presentation layer, and layer 7 is the application layer. The inspection of layers 5 through 7 distinguishes “deep packet inspection” from mere “packet inspection”.
Flow control of network traffic on the external digital network 15.
Traffic analysis and management of network traffic on the external digital network 15.
Bandwidth shaping.
Advanced routing applications.

TCP is the transport control protocol, and is used at layer 4 of the OSI model.

External digital network 15 can be any network or combination of networks where digital data is communicated. Thus, for example and without limitation, external digital network 15 can be any combination of networks from the group of networks consisting of the Internet, a wireless network, a wired network, a local area network (LAN), a wide area network (WAN), and the public switched telephone network (PSTN).

The apparatus 1 illustrated herein can be part of a system for controlling transmission of data packets through said external digital network 15, wherein each data packet comprises a header and/or a trailer and a payload portion. External digital network 15 can comprise a plurality of network-capable devices communicatively coupled to one or more Network Access Points (NAPs). In such an embodiment, the apparatus 1 illustrated herein can be disposed at a NAP or elsewhere, and can contain content match information. Said apparatus 1, and in particular FPGA 10, can be used to:
inspect payload portions of data packets transiting the NAP;
forward an inspected data packet when information within the payload portion of an inspected data packet is not substantially similar to content match information; and
when information within the payload portion of an inspected data packet is substantially similar to content match information, temporarily store the inspected data packet, and perhaps send a message to a network-capable device. These techniques are more fully described in the aforesaid U.S. patent application Ser. No. 10/037,593 filed Oct. 19, 2001, in which the Data Enabling Device (DED) of said earlier patent application can be implemented using AMC board 1 of the present invention.

The apparatus illustrated herein can also be used in an alternative method for inspecting data packets transiting a network access point (NAP). In this alternative method, reconfigurable logic device 10 inspects at least payload portions of data packets transiting the NAP, and forwards reassembled payload portions of packets, within TCP connections, as well as metadata used to identify TCP connections corresponding to said packets, to relevant peripheral devices 8. Reconfigurable logic device 10 allows an inspected data packet to traverse the network 15 when information within a payload portion of an inspected data packet is not substantially similar to prestored content match information; and when information within a payload portion of an inspected data packet is substantially similar to prestored content match information, performs at least one of the following four steps:
reports the match to at least one peripheral device 8;
prevents the packet from further traversing network 15;
allows subsequent packets from the corresponding TCP connection to pass through reconfigurable logic device 10 uninspected;
attempts to forcibly terminate the corresponding TCP connection.

In an embodiment, apparatus 1 further comprises at least one bank of SDRAM (Synchronous Dynamic Random Access Memory) 7 coupled to reconfigurable logic device 10. In an embodiment, apparatus 1 further comprises at least one bank of SRAM (Static Random Access Memory) 6 coupled to reconfigurable logic device 10.

Preferably, apparatus 1 complies with the aforesaid AdvancedMC Standard.

In an embodiment, apparatus 1 further comprises an intelligent microcontroller 9 coupled to said reprogrammable reconfigurable logic device 10, wherein said microcontroller 9 manages the power consumption of elements of apparatus 1, and performs other control functions pursuant to the AdvancedMC Standard.

Reconfigurable logic device 10 can be reprogrammed by a number of different techniques; for example:
Loading reconfigurable logic device 10 via a flash memory 5 coupled to reconfigurable logic device 10.
Reprogramming via installed JTAG (Joint Test Action Group) headers 4 coupled to reconfigurable logic device 10.
Reprogramming via JTAG headers provided on backplane 13 to which reconfigurable logic device 10 is indirectly coupled.

### 1.0 INTRODUCTION

AMC board 1 is a very high-end digital signal processing board preferably containing both PCI Express (PCIe) and 10 GigE (Ethernet) XAUI (10 Gigabit Attachment Unit Interface) interfaces 17, 11, respectively. The centerpiece of the design is preferably a Stratix II EP2S180F1508C3 FPGA device 10 from Altera 10 that interfaces to all off-board connections. High-speed RAM modules DDR (dual data rate) 2 and QDR (quad data rate) II 7, 6, respectively, support the processing functions of the FPGA 10, and a small secondary CPLD (Complex Programmable Logic Device) 3 is used to control the configuration of the Stratix II FPGA 10 from flash memory 5.

Embodiments discussed herein are illustrative only. One of ordinary skill in the art could make numerous substitutions of the various illustrated components.

### 2.0 SYSTEM OVERVIEW

AMC board 1 is a pluggable module intended for use in a MicroTCA chassis. AMC board 1 interfaces directly with a MicroTCA backplane 13. Architectural details of a MicroTCA platform are addressed in MicroTCA™, PICMG®, MTCA.0 R1.0, Micro Telecommunications Computing Architecture Short Form Specification, Sep. 21, 2006, which document is hereby incorporated by reference in its entirety into the present patent application.

AMC board 1 is a full-height, double-width PICMG AMC card featuring a Stratix II FPGA 10 as the central signal processing device, with several peripheral devices 8 that communicate off-board at multi-gigabit signaling rates. AMC board 1 is used in conjunction with other AMC modules to inspect data flows on the Internet and other digital networks 15, and it may interface off-board to a host CPU over PCI Express interface 17. The off-chip memories preferably consist of minimally 4 GB of minimally 320 MHz DDR2 memory 7, 16 MB of QDRII memory 6, and 32 MB of parallel NOR flash memory 5 used to store configuration files for the two FPGA devices 10, 16 on the board 1.

As defined in the AMC.0 specification, a module management controller (MMC) 9 resides on AMC board 1 to provide system management functions, such as board identification through Electronic Keying (E-Keying), power management, and board 1 status/fault reporting. MMC 9 communicates with a host manager on a MicroTCA MCH (MicroTCA Carrier Hub) over a 2-wire serial bus using a messaging scheme called IPMI (Intelligent Platform Management Interface), and supports a basic set of messages. An optional extended message set may be integrated into the controller 9 as well. The firmware that implements the IPMI protocols in the MMC 9 may be obtained from CorEdge Networks and may run in a Renesas H8/300H Tiny 16-bit microcontroller or other microcontroller 9.

### 2.1 Hardware System Block Diagram

FIG. 1 is the system level block diagram for AMC board 1. Note that the power distribution is not shown in FIG. 1, but is addressed in Section 6.0 below. At run-time, the AMC edge connector 12 provides all of the external I/O interfacing and power distribution. All other connectors are used for system bring-up, debug, and device programming at the factory.

### 2.2 Theory of Operation

Off-board communications occur over x4 PCI Express link 16-19 residing on AMC Ports 12-15 in the Extended Options Region of the AMC Interconnect Specification, and a 10 Gbps XAUI interface (4×2.5 Gbps) 11, which resides on AMC Ports 4-7 in the Fat Pipe region.

The x4 lane PCI Express link 16-19 is preferably implemented in a Cyclone II FPGA 16 from Altera containing a PCIe Endpoint Core from Northwest Logic (NWL). The PCI Express interface 16-19 resides externally to the Stratix II FPGA 10 and contains an integrated DMA (direct memory access) controller 18, so that upstream block data transfer control can be offloaded from the Stratix II FPGA 10. NWL's PCI Express Complete Core is a solution to the PCIe+DMA requirement, because it is an off-the-shelf module that reduces the amount of custom RTL (Register Transfer Level) that would otherwise need to be developed in order to realize the PCIe+DMA architecture in the Cyclone II FPGA 16. A top level module can be used to contain the PCIe core, a TX (transmit) FIFO for data buffering 10, and a 64-bit local bus interface that transfers the data synchronously from the Stratix II FPGA 10. The AMC board 1 is required to support only DMA host reads, and so the local DMA bus consists of a unidirectional bus from the Stratix II FPGA 10 to the Cyclone II FPGA 16. In addition to the DMA reads, a PCI target interface 19 is implemented between the two FPGAs 10, 16, so that the host can read and write individual memory mapped registers on the Stratix II FPGA 10. A secondary interface between the Stratix II FPGA 10 and the Cyclone II FPGA 16 allows the Stratix II FPGA 10 to read status information from the NWL core. This interface is a microprocessor-type parallel interface and may be driven by a soft-processor on the Stratix II FPGA 10.

The NWL PCIe core synthesizes to 21,000 logic elements, and with the additional FIFO (First In First Out) structures and interfacing circuitry in the Cyclone II FPGA 16, may fit into an EP2C35 device (35,000 logic elements). However, an EP2C50 device may be used for the AMC board 1 in order to give extra headroom during development. The EP2C35 and EP2C50 devices selected are pin compatible. The Cyclone II FPGA 16 does not feature built-in SERDES (Serializer/Deserializer); therefore, an external PCIe PHY (physical interface) 17 that interfaces to the NWL core in the Cyclone II FPGA 16 over a PIPE interface can be used. The GL9714 PCIe PHY 17 from Genesys Logic is a x4 lane currently available. A Cyclone II FPGA 16+ GL9714 17 implementation can be used.

Configuration data for the Cyclone II FPGA 16 is stored in a NOR flash device 5 along with configuration data for the Stratix II FPGA 10. As discussed below, a configuration controller implemented in a CPLD (Complex Programmable Logic Device) 3 configures the two FPGAs 10, 16 once the payload power has been applied to the AMC board 1. Storing configuration files for both FPGAs 10, 16 in the same flash 5 allows for easier maintenance in the field, as FPGA 10, 16 image updates can be downloaded over one of the off-board interfaces and written to flash 5 by the Stratix II FPGA 10. In addition to the NOR flash 5, a small serial PROM (Programmable Read Only Memory) can be optionally installed on the board 1 as a back-up method for Cyclone II FPGA 16 configuration, so that it may be booted independently of the rest of the system during board 1 bring-up and system integration.

The XAUI interface 11 is preferably implemented in an IXF18105, a 10 GigE MAC (Media Access Control device)+PHY integrated device from Cortina (Intel). The IXF18105 interface 11 communicates with the Stratix II FPGA 10 over a POS-PHY (Packet Over Sonet PHY; SONET means Synchronous Optical NETworking; PHY means PHYsical layer device) Level 4 interface, a full-duplex 16-bit (ea. direction) parallel high-speed LVDS (Low Voltage Differential Signal) bus. An Altera POS-PHY Level 4 MegaCore is then used in the Stratix II FPGA 10. As with the Cyclone II PCIe 17, a secondary microprocessor bus is used to configure the IXF18105 interface 11 and read status information. A serial MII interface between the Stratix II FPGA 10 and the IXF18105 interface 11 provides a management data interface for further control and status functionality. The Stratix II FPGA 10 drives this interface as well.

The Stratix II FPGA 10 interfaces to a variety of external memory, including 4 GB of DDR2 SDRAM 7, 16 MB of QDRII SRAM 6, and 32 MB of NOR flash 5. A single DDR2 memory bus is interfaced to the Stratix II FPGA 10, running to a pair of 2 GB DDR2 DIMMS 7 with a 72-bit data path and operating at 320 MHz. An MT18HVF25672P-667 DIMM Very Low Profile (VLP) DIMM (Dual In-Line Memory Module) designed to meet the AdvancedTCA form factor is used on the board 1.

Two QDRII memory banks 6 are preferably interfaced to the Stratix II FPGA 10. Each bank 6 is controlled using a separate memory interface on the FPGA 10. Each bank 6 is 36 bits wide and consists of a single 72 Mbit CY7C1515V18 device from Cypress. The QDRII devices 6 run at 300 MHz, the maximum rate supported by the Stratix II FPGA 10.

Both the DDR2 and QDRII interfaces in the Stratix II FPGA 10 are implemented using Altera MegaCore IP. The DDR2 SDRAM 7 High-Performance Controller MegaCore can be used, and has been tested by Altera up to an F_{MAX} of 333 MHz in a Stratix II FPGA 10. The QDRII SRAM Controller MegaCore from Altera can be used for the SRAM 6 interfaces, and is rated at a maximum operating frequency of 300 MHz. Note that in order to achieve the above interfacing speeds, dedicated DQ/DQS circuitry on the Stratix II FPGA 10 is required to capture the read data buses. We are therefore limited to the banks that support the DQ/DQS feature set (Banks 3, 4, 7, and 8).

Device configuration for both the Stratix II FPGA 10 and Cyclone II FPGA 16 is controlled by a small MAX II CPLD 3. Configuration data is stored in the flash 5 and can be updated by the Stratix II FPGA 10 over a flash interface. Two FPGA images are stored for each FPGA 10, 16—a USER image that contains the primary FPGA configuration data, and a SAFE image containing a factory installed back-up image that is never changed after the board 1 leaves the factory. The USER image may be updated in the field. For example, a new image may be downloaded to the Stratix II FPGA 10 over the PCI Express interface 17. The image is then written to the USER area of the flash 5. The Stratix II FPGA 10 (or Cyclone II FPGA 16) is then loaded with an updated image file upon a reconfiguration. Should the USER area become corrupted during a flash write operation, the FPGA 10, 16 shall be loaded with its SAFE image, providing a method to recover from a corrupted USER image.

The MAX II CPLD 3 code can be leveraged from the NIOS II development kit. Thus, it is expected that it will be a drop-in module with no custom changes required for the CPLD code.

The initial programming of the flash 5 is a special case for board 1 boot, as the MAX II CPLD 3 will need to be initially configured over JTAG connector 4 with utilities to write to the flash 5. Configuration files for both FPGAs 10, 16 may then be written to the flash 5 using the Altera provided flash loader. Flash files are uploaded to the MAX II CPLD 3 over JTAG 4 as well.

Module management controller (MMC) 9 communicates with the host processor over a 2-wire serial link and performs various system management functions defined in the AMC.0 Specification. Electronic Keying (E-Keying) allows the MMC 9 to describe to the host processor the various characteristics of the AMC board 1. The management interface is used to assign a module address for the AMC board 1 on the MicroTCA backplane 13, and ‘link descriptors’ are sent to the host by the MMC 9 that advertise how the interconnect regions on the AMC edge connector 12 have been configured. The MMC 9 also indicates to the host the amount of power that must be allocated to the AMC card 1. Cooling management operations are performed by the MMC 9 by reading on-board temperature sensors and sending temperature event messages to the MCH. The messaging protocol used to communicate between MMC 9 and host is called IPMI, and the 2-wire serial bus is referred to as IMPB-L. The MMC 9 must also drive several LEDs (Light Emitting Diodes) connected to the front faceplate 20 that indicate board 1 status.

As defined in the AMC.0 Specification, two power domains exist on the AMC board 1: a +12V Payload Domain and a +3.3V Management Domain. After an AMC board 1 has been inserted into the backplane 13, only the low-current +3.3V Management Domain is active, which powers the MMC 9 circuitry along with the faceplate 20 LEDs. The MMC 9 begins an initialization routine by indicating to the host the AMC interconnect configuration and the required power allocation for the board 1. If this initialization routine ends in a success, the host flags the MMC 9 that the +12V Payload Domain is safe for activation. All other devices on the AMC board 1 are powered by the Payload domain. The IMPI firmware can be acquired from CorEdge Networks. A Renesas H8 can be the microcontroller for the MMC 9.

### 3.0 EXTERNAL INTERFACE AND CONNECTOR PINOUTS

This section describes off-board connections. Examples of pinouts are provided, and connector part numbers are shown where available.

### 3.1 AMC Edge Connector (P2) 12

| | |
|---|---|
| Connector Part Number: | N/A |
| Manufacturer: | N/A |
| Description: | 170-pin, dual-sided, |
| | gold finger edge connector. |

*Note: Pinout is maintained in an Excel spreadsheet

TABLE 1
AMC Edge Connector 12 Pinout

| | | | | |
|---|---|---|---|---|
| Pin | | Signal Name (as | | |
| No. | Signal Name | per AMC spec) | Driven by | Pin Function |

Component Side 1

| | | | | |
|---|---|---|---|---|
| 1 | GND | GND | | Logic Ground |
| 2 | +12V_AMC | PWR | Carrier | Payload Power |
| 3 | AMC_PS1_L | PS1# | AMC | Presence 1 |
| 4 | +3P3MP_AMC | MP | Carrier | Management Power |
| 5 | AMC_GA0 | GA0 | Carrier | Geographic Addr. 0 |
| 6 | — | RSRVD6 | | Reserved |
| 7 | GND | GND | | Logic Ground |
| 8 | — | RSRVD8 | | Reserved |
| 9 | +12V_AMC | PWR | Carrier | Payload Power |
| 10 | GND | GND | | Logic Ground |
| 11 | — | Tx0+ | AMC | Port 0 Transmitter + |
| 12 | — | Tx0− | AMC | Port 0 Transmitter − |
| 13 | GND | GND | | Logic Ground |
| 14 | — | Rx0+ | Carrier | Port 0 Receiver + |
| 15 | — | Rx0− | Carrier | Port 0 Receiver − |
| 16 | GND | GND | | Logic Ground |
| 17 | AMC_GA1 | GA1 | Carrier | Geographic Addr. 1 |
| 18 | +12V_AMC | PWR | Carrier | Payload Power |
| 19 | GND | GND | | Logic Ground |
| 20 | — | Tx1+ | AMC | Port 1 Transmitter + |
| 21 | — | Tx1− | AMC | Port 1 Transmitter − |
| 22 | GND | GND | | Logic Ground |
| 23 | — | Rx1+ | Carrier | Port 1 Receiver + |
| 24 | — | Rx1− | Carrier | Port 1 Receiver − |
| 25 | GND | GND | | Logic Ground |
| 26 | AMC_GA2 | GA2 | Carrier | Geographic Addr. 2 |
| 27 | +12V_AMC | PWR | Carrier | Payload Power |
| 28 | GND | GND | | Logic Ground |
| 29 | — | Tx2+ | AMC | Port 2 Transmitter + |
| 30 | — | Tx2− | AMC | Port 2 Transmitter − |
| 31 | GND | GND | | Logic Ground |
| 32 | — | Rx2+ | Carrier | Port 2 Receiver + |
| 33 | — | Rx2− | Carrier | Port 2 Receiver − |
| 34 | GND | GND | | Logic Ground |
| 35 | — | Tx3+ | AMC | Port 3 Transmitter + |
| 36 | — | Tx3− | AMC | Port 3 Transmitter − |
| 37 | GND | GND | | Logic Ground |
| 38 | — | Rx3+ | Carrier | Port 3 Receiver + |
| 39 | — | Rx3− | Carrier | Port 3 Receiver − |
| 40 | GND | GND | | Logic Ground |
| 41 | AMC_ENABLE_L | ENABLE# | Carrier | AMC Enable |
| 42 | +12V_AMC | PWR | Carrier | Payload Power |
| 43 | GND | GND | | Logic Ground |
| 44 | XAUI_TX0p | Tx4+ | AMC | Port 4 Transmitter + |
| 45 | XAUI_TX0n | Tx4− | AMC | Port 4 Transmitter − |
| 46 | GND | GND | | Logic Ground |
| 47 | XAUI_RX0p | Rx4+ | Carrier | Port 4 Receiver + |
| 48 | XAUI_RX0n | Rx4− | Carrier | Port 4 Receiver − |
| 49 | GND | GND | | Logic Ground |
| 50 | XAUI_TX1p | Tx5+ | AMC | Port 5 Transmitter + |
| 51 | XAUI_TX1n | Tx5− | AMC | Port 5 Transmitter − |
| 52 | GND | GND | | Logic Ground |
| 53 | XAUI_RX1p | Rx5+ | Carrier | Port 5 Receiver + |
| 54 | XAUI_RX1n | Rx5− | Carrier | Port 5 Receiver − |
| 55 | GND | GND | | Logic Ground |
| 56 | AMC_SCL_L | SCL_L | IPMI_Agent | IPMB-L Clock |
| 57 | +12V_AMC | PWR | Carrier | Payload Power |
| 58 | GND | GND | | Logic Ground |
| 59 | XAUI_TX2p | Tx6+ | AMC | Port 6 Transmitter + |
| 60 | XAUI_TX2n | Tx6− | AMC | Port 6 Transmitter − |
| 61 | GND | GND | | Logic Ground |
| 62 | XAUI_RX2p | Rx6+ | Carrier | Port 6 Receiver + |
| 63 | XAUI_RX2n | Rx6− | Carrier | Port 6 Receiver − |
| 64 | GND | GND | | Logic Ground |
| 65 | XAUI_TX3p | Tx7+ | AMC | Port 7 Transmitter + |
| 66 | XAUI_TX3n | Tx7− | AMC | Port 7 Transmitter − |
| 67 | GND | GND | | Logic Ground |
| 68 | XAUI_RX3p | Rx7+ | Carrier | Port 7 Receiver + |
| 69 | XAUI_RX3n | Rx7− | Carrier | Port 7 Receiver − |
| 70 | GND | GND | | Logic Ground |
| 71 | AMC_SDA_L | SDA_L | IPMI_Agent | IPMB-L Data |
| 72 | +12V_AMC | PWR | Carrier | Payload Power |
| 73 | GND | GND | | Logic Ground |
| 74 | — | CLK1+ | CLK1 driver | Synchronous Clock 1+ |
| | | (TCLKA+) | | |
| 75 | — | CLK1− (TCLKA−) | CLK1 driver | Synchronous Clock 1− |
| 76 | GND | GND | | Logic Ground |
| 77 | — | CLK2+ | CLK2 driver | Synchronous Clock 2+ |
| | | (TCLKB+) | | |
| 78 | — | CLK2− (TCLKB−) | CLK2 driver | Synchronous Clock 2− |
| 79 | GND | GND | | Logic Ground |
| 80 | PCIE_CLK_100 MHZp | CLK3+ | CLK3 driver | Synchronous Clock 3+ |
| | | (FCLKA+) | | |
| 81 | PCIE_CLK_100 MHZn | CLK3− (FCLKA−) | CLK3 driver | Synchronous Clock 3− |
| 82 | GND | GND | | Logic Ground |
| 83 | AMC_PS0_L | PS0# | Carrier | Presence 0 |
| 84 | +12V_AMC | PWR | Carrier | Payload Power |
| 85 | GND | GND | | Logic Ground |

Component Side 2

| | | | | |
|---|---|---|---|---|
| 170 | GND | GND | | Logic Ground |
| 169 | AMC_TDI | TDI | Carrier | JTAG Test Data Input |
| 168 | AMC_TDO | TDO | AMC | JTAG Test Data Output |
| 167 | AMC_TRST_L | TRST# | Carrier | JTAG Test Reset Input |
| 166 | AMC_TMS | TMS | Carrier | JTAG Test Mode Select In |
| 165 | AMC_TCK | TCK | Carrier | JTAG Test Clock Input |
| 164 | GND | GND | | Logic Ground |
| 163 | — | Tx20+ | AMC | Port 20 Transmitter + |
| 162 | — | Tx20− | AMC | Port 20 Transmitter − |
| 161 | GND | GND | | Logic Ground |
| 160 | — | Rx20+ | Carrier | Port 20 Receiver + |
| 159 | — | Rx20− | Carrier | Port 20 Receiver − |
| 158 | GND | GND | | Logic Ground |
| 157 | — | Tx19+ | AMC | Port 19 Transmitter + |
| 156 | — | Tx19− | AMC | Port 19 Transmitter − |
| 155 | GND | GND | | Logic Ground |
| 154 | — | Rx19+ | Carrier | Port 19 Receiver + |
| 153 | — | Rx19− | Carrier | Port 19 Receiver − |
| 152 | GND | GND | | Logic Ground |
| 151 | — | Tx18+ | AMC | Port 18 Transmitter + |
| 150 | — | Tx18− | AMC | Port 18 Transmitter − |
| 149 | GND | GND | | Logic Ground |
| 148 | — | Rx18+ | Carrier | Port 18 Receiver + |
| 147 | — | Rx18− | Carrier | Port 18 Receiver − |
| 146 | GND | GND | | Logic Ground |
| 145 | — | Tx17+ | AMC | Port 17 Transmitter + |
| 144 | — | Tx17− | AMC | Port 17 Transmitter − |
| 143 | GND | GND | | Logic Ground |
| 142 | — | Rx17+ | Carrier | Port 17 Receiver + |
| 141 | — | Rx17− | Carrier | Port 17 Receiver − |
| 140 | GND | GND | | Logic Ground |
| 139 | — | Tx16+ | AMC | Port 16 Transmitter + |
| | | (TCLKD+) | | |
| 138 | — | Tx16− | AMC | Port 16 Transmitter − |
| | | (TCLKD−) | | |
| 137 | GND | GND | | Logic Ground |
| 136 | — | Rx16+ | Carrier | Port 16 Receiver + |
| | | (TCLKC+) | | |
| 135 | — | Rx16− | Carrier | Port 16 Receiver − |
| | | (TCLKC−) | | |
| 134 | GND | GND | | Logic Ground |
| 133 | PCIE_LN3_TXp | Tx15+ | AMC | Port 15 Transmitter + |
| 132 | PCIE_LN3_TXn | Tx15− | AMC | Port 15 Transmitter − |
| 131 | GND | GND | | Logic Ground |
| 130 | PCIE_LN3_RXp | Rx15+ | Carrier | Port 15 Receiver + |
| 129 | PCIE_LN3_RXn | Rx15− | Carrier | Port 15 Receiver − |
| 128 | GND | GND | | Logic Ground |
| 127 | PCIE_LN2_TXp | Tx14+ | AMC | Port 14 Transmitter + |
| 126 | PCIE_LN2_TXn | Tx14− | AMC | Port 14 Transmitter − |
| 125 | GND | GND | | Logic Ground |
| 124 | PCIE_LN2_RXp | Rx14+ | Carrier | Port 14 Receiver + |
| 123 | PCIE_LN2_RXn | Rx14− | Carrier | Port 14 Receiver − |
| 122 | GND | GND | | Logic Ground |
| 121 | PCIE_LN1_TXp | Tx13+ | AMC | Port 13 Transmitter + |
| 120 | PCIE_LN1_TXn | Tx13− | AMC | Port 13 Transmitter − |
| 119 | GND | GND | | Logic Ground |
| 118 | PCIE_LN1_RXp | Rx13+ | Carrier | Port 13 Receiver + |
| 117 | PCIE_LN1_RXn | Rx13− | Carrier | Port 13 Receiver − |
| 116 | GND | GND | | Logic Ground |
| 115 | PCIE_LN0_TXp | Tx12+ | AMC | Port 12 Transmitter + |
| 114 | PCIE_LN0_TXn | Tx12− | AMC | Port 12 Transmitter − |
| 113 | GND | GND | | Logic Ground |
| 112 | PCIE_LN0_RXp | Rx12+ | Carrier | Port 12 Receiver + |
| 111 | PCIE_LN0_RXn | Rx12− | Carrier | Port 12 Receiver − |
| 110 | GND | GND | | Logic Ground |
| 109 | — | Tx11+ | AMC | Port 11 Transmitter + |
| 108 | — | Tx11− | AMC | Port 11 Transmitter − |
| 107 | GND | GND | | Logic Ground |
| 106 | — | Rx11+ | Carrier | Port 11 Receiver + |
| 105 | — | Rx11− | Carrier | Port 11 Receiver − |
| 104 | GND | GND | | Logic Ground |
| 103 | — | Tx10+ | AMC | Port 10 Transmitter + |
| 102 | — | Tx10− | AMC | Port 10 Transmitter − |
| 101 | GND | GND | | Logic Ground |
| 100 | — | Rx10+ | Carrier | Port 10 Receiver + |
| 99 | — | Rx10− | Carrier | Port 10 Receiver − |
| 98 | GND | GND | | Logic Ground |
| 97 | — | Tx9+ | AMC | Port 9 Transmitter + |
| 96 | — | Tx9− | AMC | Port 9 Transmitter − |
| 95 | GND | GND | | Logic Ground |
| 94 | — | Rx9+ | Carrier | Port 9 Receiver + |
| 93 | — | Rx9− | Carrier | Port 9 Receiver − |
| 92 | GND | GND | | Logic Ground |
| 91 | — | Tx8+ | AMC | Port 8 Transmitter + |
| 90 | — | Tx8− | AMC | Port 8 Transmitter − |
| 89 | GND | GND | | Logic Ground |
| 88 | — | Rx8+ | Carrier | Port 8 Receiver + |
| 87 | — | Rx8− | Carrier | Port 8 Receiver − |
| 86 | GND | GND | | Logic Ground |

### 3.2 AMC 1 Faceplate 20

A faceplate 20 installed on the front of the module provides LED visual feedback to the user, as well as EMC containment and other mechanical functions described in Section 8.0. The LEDs are mounted on the AMC board PCB (printed circuit board) 1 as directed by the AMC.0 Base Specification in order to be visible in faceplate 20.

| | |
|---|---|
| Connector Part Number: | N/A |
| Manufacturer: | Schroff can be used |
| Description: | AMC front faceplate 20, compliant |
| | with the AMC.0 Specification. |

TABLE 2
Faceplate 20 LED Signal Descriptions

| Signal | Description |
|---|---|
| BLUE | Provides Hot Swap status to the user. This signal is connected |
| LED | to the MMC 9. |
| LED1 | Provides failure and out of service feedback to the user. When |
| | used, this signal is connected to the MMC 9. |

### 3.3 FPGA JTAG Connector (P1) 4

| | |
|---|---|
| Connector Part Number: | TSW-105-26-L-D |
| Manufacturer: | Samtec |
| Description: | 10-pin, 0.100″ header, |
| | dual row (2 × 5), male |

TABLE 3
FPGA JTAG Connector 4 Pinout

| Pin# | Signal | Description |
|---|---|---|
| 1 | CONN_FPGA_TCK | TCK JTAG signal on |
| | | FPGA JTAG Connector |
| 2 | GND | Ground |
| 3 | CONN_FPGA_TDO | TDO JTAG signal on |
| | | FPGA JTAG Connector |
| 4 | VDD | +3.3 V |
| 5 | CONN_FPGA_TMS | TMS JTAG signal on |
| | | FPGA JTAG Connector |
| 6 | NC | No Connect |
| 7 | CONN_TRST | TRST JTAG signal on |
| | | FPGA JTAG Connector |
| 8 | NC | No Connect |
| 9 | CONN_FPGA_TDI | TDI JTAG signal on |
| | | FPGA JTAG Connector. |
| 10 | GND | Ground |

### 3.4 MMC Programming Connector (J6) 2

| | |
|---|---|
| Connector Part Number: | FTSH-110-01-L-DV-K |
| Manufacturer: | Samtec |
| Description: | 20-pin, 0.050″ header, |
| | dual row (2 × 10), male |

TABLE 4
MMC.Programming Connector 2 Pinout

| Pin# | Signal | Description |
|---|---|---|
| 1 | +3P3MP | +3.3 V Management Power |
| 2 | GND | Ground |
| 3 | H8_TX_TTL | H8 serial UART TX signal |
| 4 | GND | Ground |
| 5 | H8_RX_TTL | H8 serial UART RX signal |
| 6 | GND | Ground |
| 7 | H8_RST_L | H8 Reset signal |
| 8 | GND | Ground |
| 9 | — | No Connect |
| 10 | GND | Ground |
| 11 | NMI_L | H8 interrupt signal |
| 12 | GND | Ground |
| 13 | MMC_P85 | H8 I/O signal |
| 14 | GND | Ground |
| 15 | BLUE_LED | H8 I/O signal |
| 16 | GND | Ground |
| 17 | RED_LED | H8 I/O signal |
| 18 | GND | Ground |
| 19 | — | No Connect |
| 20 | — | No Connect |

### 3.5 UART Breakout Connector (P4) 21

The UART (Universal Asynchronous Receiver/Transmitter) breakout connector 21 mates with a small DB-9 expansion board designed by Nuvation. The intended use is for system debug during the integration stage.

| | |
|---|---|
| Connector Part Number: | FTS-105-01-L-DV |
| Manufacturer: | Samtec |
| Description: | 10-pin header, dual row, |
| | surface mount, 0.05″ pitch |

TABLE 5
UART Breakout Connector 21 Pinout

| Pin# | Signal | Description |
|---|---|---|
| 1 | SX_UART_TX | TX UART signal from Stratix II |
| 2 | — | No Connect |
| 3 | SX_UART_RX | RX UART signal to Stratix II |
| 4 | — | No Connect |
| 5 | GND | Ground |
| 6 | GND | Ground |
| 7 | H8_TX_TTL | TX UART signal from H8 |
| 8 | — | No Connect |
| 9 | H8_RX_TTL | RX UART signal to H8 |
| 10 | — | No Connect |

### Auxiliary Power Connector (P3) 22

The auxiliary power connector 22 may be used to provide power to the board 1 when not connected to the AMC chassis slot 13 (e.g., for debug or testing).

| | |
|---|---|
| Connector Part Number: | IPL1-110-02-L-D. |
| Manufacturer: | Samtec |
| Description: | 20-pin header, dual row, surface mount, |
| | 0.1″ pitch |

TABLE 6
Auxiliary Power Connector 22 Pinout

| Pin# | Signal | Description |
|---|---|---|
| 1 | +12 VD | +12 V Payload Power |
| 2 | +12 VD | +12 V Payload Power |
| 3 | +12 VD | +12 V Payload Power |
| 4 | GND | Ground |
| 5 | GND | Ground |
| 6 | GND | Ground |
| 7 | GND | Ground |
| 8 | GND | Ground |
| 9 | GND | Ground |
| 10 | +3P3MP_DBG | +3.3 V Management Power |
| 11 | +12 VD | +12 V Payload Power |
| 12 | +12 VD | +12 V Payload Power |
| 13 | +12 VD | +12 V Payload Power |
| 14 | GND | Ground |
| 15 | GND | Ground |
| 16 | GND | Ground |
| 17 | GND | Ground |
| 18 | GND | Ground |
| 19 | GND | Ground |
| 20 | +3P3MP_DBG | +3.3 V Management Power |

### 3.6 Debug Connector (J5) 25

Debug Mictor connector 25 is mounted on the board 1 to provide I/O access to the Stratix II FPGA 10. The Mictor connector 25 has a standard pinout that is compatible with an Agilent Logic Analyzer (Model #E536 or equivalent).

| | |
|---|---|
| Connector Part Number: | 2-767004-2 |
| Manufacturer: | TYCO |
| Description: | 38-pin Mictor Connector |

TABLE 7
Debug Connector 25 Pinout

| Pin# | Signal | Description |
|---|---|---|
| 1 | — | No Connect |
| 2 | — | No Connect |
| 3 | Gnd | Ground |
| 4 | — | No Connect |
| 5 | SX_DBG_CLK_OUT0 | Debug Channel 1 Clock |
| 6 | SX_DBG_CLK_OUT1 | Debug Channel 2 Clock |
| 7 | SX_DBG15 | Debug Channel 1 Bit 15 |
| 8 | SX_DBG31 | Debug Channel 2 Bit 15 |
| 9 | SX_DBG14 | Debug Channel 1 Bit 14 |
| 10 | SX_DBG30 | Debug Channel 2 Bit 14 |
| 11 | SX_DBG13 | Debug Channel 1 Bit 13 |
| 12 | SX_DBG29 | Debug Channel 2 Bit 13 |
| 13 | SX_DBG12 | Debug Channel 1 Bit 12 |
| 14 | SX_DBG28 | Debug Channel 2 Bit 12 |
| 15 | SX_DBG11 | Debug Channel 1 Bit 11 |
| 16 | SX_DBG27 | Debug Channel 2 Bit 11 |
| 17 | SX_DBG10 | Debug Channel 1 Bit 10 |
| 18 | SX_DBG26 | Debug Channel 2 Bit 10 |
| 19 | SX_DBG9 | Debug Channel 1 Bit 9 |
| 20 | SX_DBG25 | Debug Channel 2 Bit 9 |
| 21 | SX_DBG8 | Debug Channel 1 Bit 8 |
| 22 | SX_DBG24 | Debug Channel 2 Bit 8 |
| 23 | SX_DBG7 | Debug Channel 1 Bit 7 |
| 24 | SX_DBG23 | Debug Channel 2 Bit 7 |
| 25 | SX_DBG6 | Debug Channel 1 Bit 6 |
| 26 | SX_DBG22 | Debug Channel 2 Bit 6 |
| 27 | SX_DBG5 | Debug Channel 1 Bit 5 |
| 28 | SX_DBG21 | Debug Channel 2 Bit 5 |
| 29 | SX_DBG4 | Debug Channel 1 Bit 4 |
| 30 | SX_DBG20 | Debug Channel 2 Bit 4 |
| 31 | SX_DBG3 | Debug Channel 1 Bit 3 |
| 32 | SX_DBG19 | Debug Channel 2 Bit 3 |
| 33 | SX_DBG2 | Debug Channel 1 Bit 2 |
| 34 | SX_DBG18 | Debug Channel 2 Bit 2 |
| 35 | SX_DBG1 | Debug Channel 1 Bit 1 |
| 36 | SX_DBG17 | Debug Channel 2 Bit 1 |
| 37 | SX_DBG0 | Debug Channel 1 Bit 0 |
| 38 | SX_DBG16 | Debug Channel 2 Bit 0 |

### 4.0 MAJOR COMPONENTS AND INTERNAL INTERCONNECTS

The following section discusses the main IC's on the AMC board 1 and their respective interconnections. Descriptions of the interfaces are given and exact signals are shown when appropriate.

### 4.1 Stratix II EP2S180F1508C3 FPGA 10

The centerpiece of the AMC board 1 is a Stratix II FPGA 10 from Altera. An EP2S180F1508C3 can be used, which offers 180,000 logic elements, 9.4 Mbits of RAM, and is packaged in a 1 mm pitch 1508-ball FBGA.

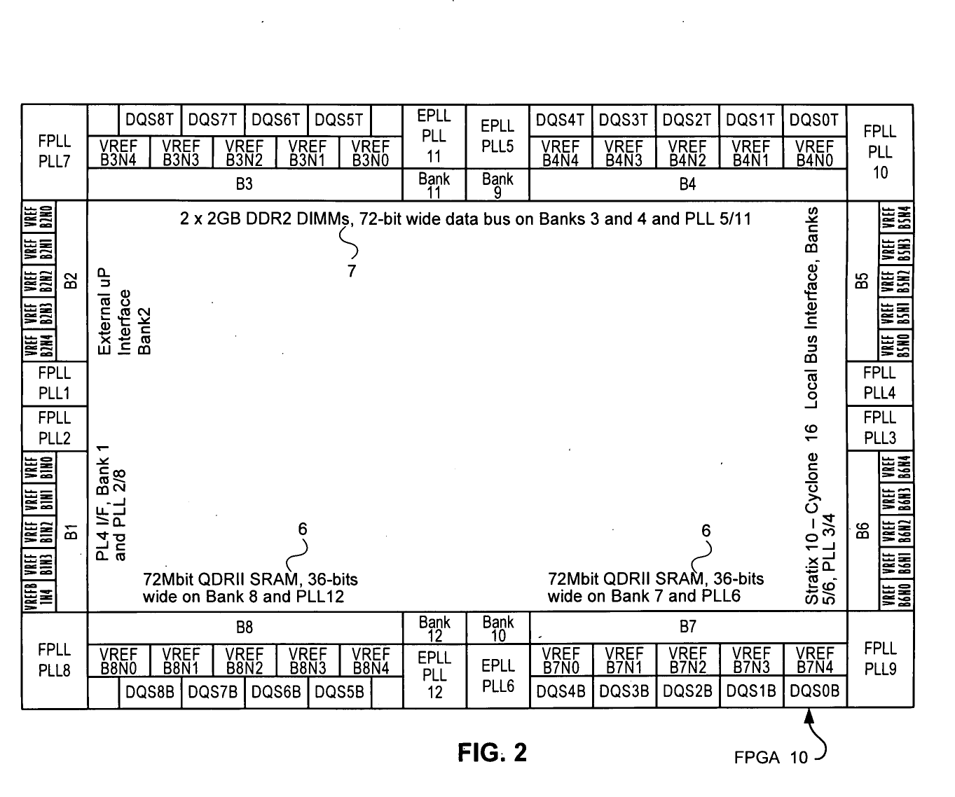

Shown in FIG. 2 are the I/O banks of the EP2S180 FPGA 10.

The internal logic of the Stratix II FPGA 10 is powered from a 1.2V rail. As with most Altera FPGAs, its I/O banks support a variety of I/O standards, ranging from 1.2V to 3.3V. The Stratix II FPGA 10 on the AMC board 1 has four of its I/O banks used for high-speed DDR2 7 and QDRII 6 powered at 1.8V, one of its LVDS enabled banks shall be powered at 2.5V, and the remaining low-speed I/Os shall use LVTTL 2.5V/3.3V logic levels.

### 4.1.1 FPGA 10 Clocking

Table 8 below shows the PLL (phase lock loop) usage in the Stratix II FPGA 10. A single 40 MHz input clock provides the source for all other clocks used on the device 10. The 40 MHz clock is multiplied up to a maximum of 320 MHz using PLL1, which becomes the main global clock for the Stratix II FPGA 10. The remaining PLL's are used to produce clocks for the external synchronous memory interfaces and the source-synchronous parallel buses that run between the Stratix II FPGA 10 and the other devices on the AMC board 1.

TABLE 8
PLL Usage in Stratix II FPGA 10

| | PLL | | |
|---|---|---|---|
| PLL # | Type | Input Clock | Output Clock(s) |
| 1 | Fast | 40 MHz Ext. | 320 MHz Global Clock |
| | | | 40 MHz Global Clock output, used by other PLL's to |
| | | | generate clocks. |
| 2 | Fast | RDCLK (340 MHz | rdint_clk (deserialized output clock from the LVDS |
| | | PL4 Rx Clk) | Receive PLL) |
| 3 | Fast | Output of PLL4 | 62.5 MHz Source-Synchronous TX Clock for Cyclone- |
| | | | Stratix Bus |
| 4 | Fast | From Cyclone (Clock | 62.5 MHz local clock for Source-Synchronous RX Clock |
| | | input pin) | for Cyclone-Stratix Bus |
| 5 | Enhanced | 40 MHz GCLK | 320 MHz System Clock for DDR2 |
| | | 40 MHz Ext. | 320 MHz Write Clock for DDR2 |
| | | | 320 MHz Refclk for DQS phase-shifter |
| 6 | Enhanced | 40 MHz GCLK | 300 MHz system clock for QDRII write side PLL (bank 2) |
| | | 40 MHz Ext. | 300 MHz Write Clock for QDRII (bank 2) |
| | | | 300 MHz Refclk for DQS phase-shifter |
| 7 | Fast | Not used | |
| 8 | Fast | 40 MHz GCLK | td_clk (PL4 Tx clock running at 340 MHz) |
| | | 40 MHz Ext. | |
| 9 | Fast | Not used | |
| 10 | Fast | Not used | |
| 11 | Enhanced | FB_CLK pin | 320 MHz read clock to aid DDR2 read data |
| | | | resynchronization. |
| 12 | Enhanced | 40 MHz GCLK | 300 MHz system clock for QDRII write side PLL (bank 1) |
| | | | 300 MHz Write Clock for QDRII (bank 1) |

### 4.1.2 FPGA 10 Configuration

Configuration data for the Stratix II FPGA 10 is stored in a 32 MB flash device 5. The FPGA 10 is preferably loaded with configuration data by a MAX-II EPM1270 CPLD 3, which contains a flash bootloader Altera IP block designed to read out data from the flash 5 and drive the configuration pins on the FPGA 10. The Stratix II FPGA 10 and the Cyclone II FPGA 16 are configured sequentially by daisy chaining their configuration signals in a Passive Serial configuration scheme. At a DCLK frequency of 40 MHz, the estimated time to configure the Stratix II EP2S180 10 in Passive Serial mode is approximately one second.

The FPGA 10 may also be configured using its JTAG port and JTAG connector 4. This can be useful during bring-up time to load the FPGA 10 directly from Quartus using a Byte Blaster cable.

### 4.1.3 Stratix II FPGA 10 External Interfaces and Pinout

### DDR2 SDRAM Memory 7

Interfaced to the Stratix II FPGA 10 I/O Banks 3 and 4 is a 72-bit wide DDR2 memory bus running to a pair of DIMMs 7. The memory interface uses dedicated DQ/DQS signals and DQS phase-shifting circuitry, allowing it to run at 320 MHz. PLL5 is used to generate the system clock, write clock, and DQS phase-shifter reference clock, while PLL11 generates a read clock used to help resynchronize data read from the memory back to the system clock domain. PLL11 is referenced to a FB_CLK external signal, whose frequency is equal to the system clock and whose phase is closely matched to the trace round-trip propagation delay from the FPGA 10 to memory 7.

I/O Banks 3 and 4 use a SSTL_18 logic standard and require a VCCIO of 1.8V. The two DIMMs 7 are both 240-pin, 72-bit wide, very-low profile (VLP) modules that reside in parallel on the DDR2 bus. To the memory controller, the bus therefore looks like one 72-bit bus that is 4 GB deep. A Micron MT18HVF25672PY-667 VLPDIMM 7 targeted for a low-profile application in an AdvancedTCA form factor can be used. Table 9 lists the external signals running between the FPGA 10 and the DIMM 7 connectors.

TABLE 9
DDR2 Memory 7 Interface External Signals

| Signal | Stratix II Pin Type | Description |
|---|---|---|
| CKp/CKn | I/O pins | External clock signals to |
| | | memory modules |
| CKE0, CKE1 | I/O pins | Clock enable signals |
| S0-S3 | I/O pins | Chip select. S0-S1 are routed |
| | | to DIMM 1, S2-S3 |
| | | are routed to DIMM 2. |
| DQ0-DQ63 | Dedicated DQ pins | Data bus |
| CB0-CB7 | Dedicated DQ pins | ECC check bits. |
| DQS0-DQS17 | Dedicated DQS pins | Data strobe signals. |
| RAS#, CAS#, | I/O pins | Control signals. |
| WE#, BA0-BA1, | | |
| others | | |
| A0-A13 | I/O pins | Address signals |
| FB_CLK | I/O pin routed to | Reference clock for Read PLL. |
| | PLL11 input pin. | |
| ERR_OUT | I/O | Parity error signal |
| | | (address/control bus) |

### QDRII SRAM Memory 6

Interfaced to the Stratix II FPGA 10 I/O Banks 7 and 8 are two 36-bit QDRII memory buses, with each one using a separate memory controller to interface to a Cypress CY7C1515V8 device 6. The memory interface uses dedicated DQ/DQS signals and DQS phase shifting circuitry, allowing it to run at 300 MHz. PLL6 generates the system clock, write clock, and DQS phase-shifter reference clock for one of the QDRII memory banks 6, while PLL12 generates a similar set of clocks for the other QDRII memory bank 6, minus the reference clock for the DQS phase-shifter. (Only one reference clock is required for the DQS phase shifter circuitry.)

I/O Banks 7 and 8 use a SSTL_18 logic standard and require a VCCIO of 1.8V. The Cypress memory device 6 is a 72 Mbit capacity part, with a 36-bit data bus, and a maximum operating frequency of 300 MHz. Table 10 lists the external signals running between the FPGA 10 and each QDRII device 6.

TABLE 10
QDRII Memory 6 Interface External Signals

| | Stratix II Pin | |
|---|---|---|
| Signal | Type | Description |
| K/K# | I/O pins | External write clock signals to |
| | | memory modules |
| CQ/CQ# | DQS pins | Echo clock used to strobe in Q data bus. |
| D0-D35 | I/O pins | Data bus write output to memory |
| Q0-Q35 | DQ pins | Data bus read input from memory |
| WPSn, RPSn, | I/O pins | Control signals. |
| others | | |
| A0-A18 | I/O pins | Address signals |

### POS-PHY Level 4 (IXF18105) Interface 11

A POS-PHY Level 4 (PL4) interface on the Stratix II FPGA 10 provides access to a 10 GigE MAC/PHY that communicates off-board over a XAUI interface 11. An IXF18105 from Cortina can be used to implement the 10 GigE functions.

The PL4 MegaCore in the Stratix II FPGA 10 transmits and receives data on I/O Bank 1 using the LVDS signaling standard. A 16-bit parallel bus in each direction forms a source-synchronous bus operating at 680 Megacycles per second, with a half-frequency clock. The IXF18105 interface 11 is configured in slave mode, meaning that its Receive Data clock (from MAC to Stratix II FPGA 10) is derived from its Transmit Data clock originating at the Stratix II FPGA 10. Two PLL's (2 & 8) are therefore used on the FPGA 10, one to clock out the 16-bit transmit bus and the other to clock in the 16-bit receive bus from the IXF18105 11. PLL8, which generates the Transmit Data clock, therefore determines the clocking speed of the entire PL4 interface. The input clock for PLL8 is sourced from a 40 MHz global clock output from PLL1, which is then multiplied up to 340 MHz in order to clock out the PL4 data at double data rate. The PL4 interface signals are shown below in Table 11.

TABLE 11
POS-PHY Level 4 Interface 11 Signals

| | Direction (Relative | |
|---|---|---|
| Signal | to Stratix II) | Description |
| TDCLK | Output | Differential transmit clock |
| | | synchronous to TCTL and TDAT. |
| TCTL | Output | Differential transmit control signal. |
| TDAT[15:0] | Output | Differential Parallel transmit bus. |
| TSCLK | Input | Input transmit status clock. |
| | | Frequency is divided |
| | | down from TDCLK |
| TSTAT | Input | Input transmit status signal. |
| RDCLK | Input | Differential receive clock |
| | | synchronous to RCTL and RDAT. |
| RCTL | Input | Differential receive control signal. |
| RDAT[15:0] | Input | Differential receive data signal. |
| RSCLK | Output | Output receive status clock signal. |
| | | Frequency is divided down |
| | | from RDCLK. |
| RSTAT[1:0] | Output | Output receive status signal. |

In addition to the PL4 interface, a secondary microprocessor interface exists between the Stratix II FPGA 10 and the IXF18105 interface 11 that is used by the FPGA 10 to configure the 10 GigE MAC/PHY and read status information. This interface is available on the Stratix II FPGA 10 External Address/Data Interface and is described below.

### Cyclone II FPGA 16 Local Bus Interfaces

A 64-bit unidirectional DDR DMA bus interface is used to transfer DMA blocks from the Stratix II FPGA 10 to the Cyclone II FPGA 16. A PCI target interface 19 is also provided so that the Stratix II FPGA 10 is visible as a PCI device to the host CPU. The PCI target bus is a full-duplex 64-bit bus. See Section 4.3.3 for a discussion of these buses.

### CPLD 3 and Flash 5

In addition to the configuration CPLD 3, the flash address and data buses run to the Stratix II FPGA 10 so that it may write data to the configuration flash 5. The flash 5 is configured in byte-wide mode.

A 32 MB S29GL256 parallel NOR flash 5 from Spansion can be used to store the configuration data. The EP2S180 FPGA 10 requires an uncompressed bit file size of 6.25 MB, and the Cyclone II FPGA 16 EP2C50 FPGA 16 requires a bit file size of 1.25 MB. Therefore, two FPGA images for each device 10, 16 consume a total of 14 MB of flash memory, leaving plenty of room for other user data.

### MMC Microcontroller 9

A communications link between the Stratix II FPGA 10 and the Renesas H8 MMC controller 9 is provided so that status information can be shared between the two devices 10, 9. Several signals interfaced to a serial port on the H8 MMC 9 are routed to the Stratix II FPGA 10, which may then run to a serial port instantiation on the FPGA 10.

### LEDs, Test Points, and Debug

Extra GPIO signals from the Stratix II FPGA 10 are brought out to LEDs, test points, and debug connectors. The number of peripheral components that can be accommodated depends on the available board 1 real estate and the number of remaining unused GPIO pins on the Stratix II FPGA 10.

### 4.2 IXF18105 Processor 11

The IXF18105 processor 11 from Cortina is a 10 Gigabit Ethernet MAC and PHY that communicates with the Stratix II FPGA 10 over a POS-PHY Level 4 interface on the system side and a XAUI interface on the line side. The device 11 performs Ethernet frame generation, frame integrity checks, and 8b/10b encoding. The built-in SERDES for the 4×3.125 Gbps XAUI interface allows for a single chip solution for the 10 GigE interface external to the Stratix II FPGA 10. The device 11 is packaged in a 672-ball FCBGA and uses a 2.5V supply to power its core logic (and XAUI analog PLLs), and uses a 3.3V for its digital I/O circuitry.

### 4.2.1 IXF18105 Processor 11 Clocking

As discussed above, the IXF18105 processor 11 PL4 interface is configured in slave mode, meaning that the clock source for the interface is driven by the Stratix II FPGA 10. The 340 MHz PLL output from the Stratix II FPGA 10 clock provides the timing for the entire PL4 interface and internal logic. The Line side of the IXF18105 processor 11 uses a XAUI_REFCLK for generating the transmit data and for the Clock Recover Circuit of the receive path. The XAUI_REFCLK must be provided from a stable 312.5 MHz +/−100 ppm LVDS input. For best jitter performance, a standalone clock reference is used for the XAUI_REFCLK, powered from a clean source.

### 4.2.2 IXF18105 Processor 11 External Bus Interfaces

### POS-PHY Level 4 (Stratix II)

The interface is discussed above in Section 4.1.3.

### XAUI External Interface

The high-speed 4×3.125 GHz signals are AC coupled and routed directly to the AMC edge connector 12. There are four LVDS pairs in each direction, providing a total bandwidth of 12.5 Gbps before 8b/10b encoding. The IXF18105 processor 11 actually provides two 4×3.125 GHz interfaces: a working, or primary, interface and an auxiliary interface. The auxiliary interface is intended to support optical failure in cable transmission applications, and need not be used on the AMC board 1. The primary XAUI interface 11 interfaces to AMC Ports 4-7 on the AMC edge connector 12 (Section 3.1).

### 4.2.3 IXF18105 Processor 11 Debug Utilities

Status and debug utilities for the IXF18105 processor 11 are implemented over the Microprocessor Interface. Key control and status signals for the device 11 are brought to testpoints for probing, unless there is a risk that a compromise in the integrity of the signal will result.

### 4.3 Cyclone II FPGA 16 EP2C35 FPGA 16 and GL9714 PCI Express PHY 17

The Cyclone II Altera FPGA 16 implements a x4 Lane PCI Express off-board link using the PCI Express Complete Core from Northwest Logic, and can be viewed as a peripheral device to the Stratix II FPGA 10. The Cyclone II model number can be the EP2C35, which contains 33,216 logic elements, 484 kbits of RAM, and 4 PLLs. However, a larger EP2C50 device can be used for flexibility.

A 1.2V rail powers the Cyclone II FPGA 16 logic core, and its I/O banks require a 2.5V supply for its high-speed SSTL_{—}2 I/Os and a 3.3V rail for its general purpose LVTTL I/Os. The 672-pin FBGA package can be used, which offers up to 450 I/O pins in the EP2C50 16 device. Shown below are the I/O Banks of the Cyclone II FPGA 16 EP2C35 16.

As the Cyclone II FPGA 16 does not support the PCIe multi-gigabit signaling rates, the device uses an off-chip PHY to implement the SERDES functions and Physical Coding Sublayer for the PCIe signals. The GL9714 device 17 from Genesys Logic is a x4 lane PHY that performs 8b/10b encoding, elastic buffer and receiver detection, and data serialization/deserialization for each lane. The Cyclone II FPGA 16 and GL9714 device 17 communicate over a 250 MHz PIPE parallel interface.

The following sections give an overview of the Cyclone II FPGA 16 clocking and external interfaces.

### 4.3.1 Cyclone II FPGA 16 Clocking

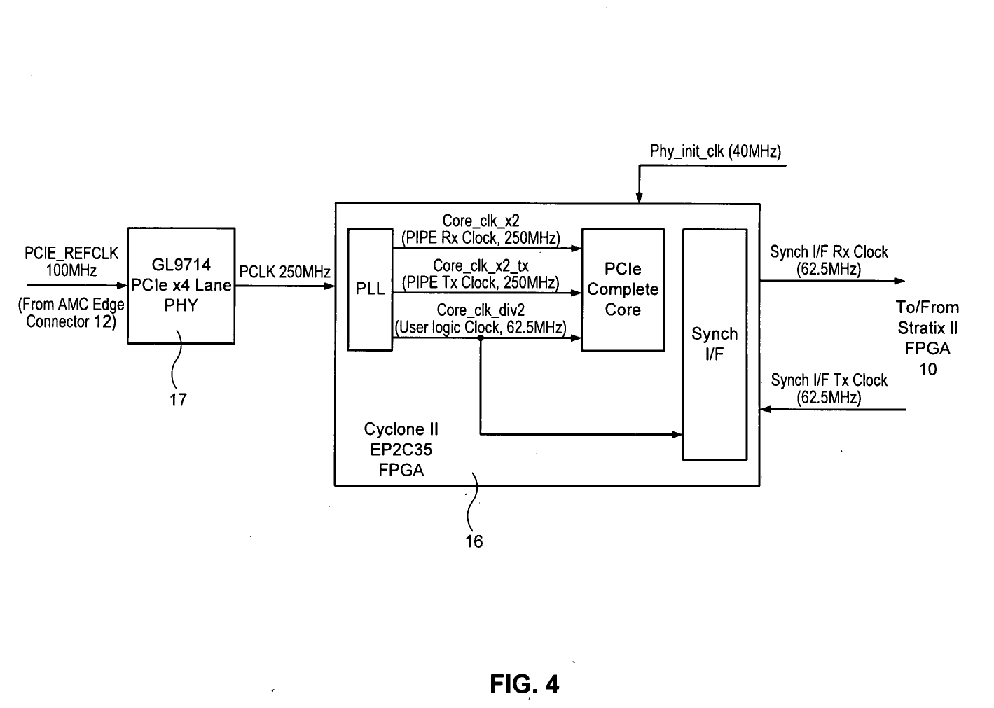

The clocking architecture for the Cyclone II FPGA 16 is shown in FIG. 4. The 100 MHz PCIE_REFCLK from the AMC edge connector 12 drives the clocking for the entire PCI Express data path, helping to mitigate issues created by multiple clock domains and clock frequency mismatches.

A 250 MHz PCLK is generated by the PLL onboard the GL9714 device 17 and is used to transfer the PIPE data in both directions between the PHY and the Cyclone II FPGA 16. The two buses are not source-synchronous, however, as PCLK is fed to a PLL on the Cyclone II FPGA 16 in order to generate the clock strobe signals for the Tx and Rx PIPE buses. The PLL parameters can be configured once the routing delays for the PIPE bus are known. Note that the Cyclone II FPGA 16+GL9714 architecture is based on a NWL reference design for their PCIe core.

Another output from the Cyclone II FPGA 16 PLL, core_clk_div2, is a 62.5 MHz system clock to which the system side user logic is synchronized. Core_clk_div2 is used to clock data over the 64-bit DDR DMA interface, as well as the 64-bit PCI Target interface, between the Cyclone II FPGA 16 and Stratix II FPGA 10. This architecture maintains a single clock domain in the Cyclone II FPGA 16 for the PCIe datapath.

A secondary clock is required by the PCIe core during board 1 initialization in order to boot and configure the GL9714 device 17. Phy_init_clk is a 40 MHz secondary clock input to the FPGA 16, used by the PCIe core to initialize the PHY, as its PCLK output will not be valid until its internal PLL has stabilized.

### 4.3.2 Cyclone II FPGA 16 Configuration

Configuration data for the Cyclone II FPGA 16 is stored on the parallel flash 5. As discussed in Section 4.1.2, a MAX II CPLD 3 handles the configuration of the two FPGAs 10, 16 over a Passive Serial interface. Unlike the Stratix II FPGA 10, however, the Cyclone II FPGA 16 does not have direct access to the flash 5.

Two secondary methods of device configuration are available for the Cyclone II FPGA 16 as well. A JTAG interface allows the loading of an FPGA 16 image file from Quartus (Altera's proprietary software for the design of applications for Altera devices). Furthermore, a small serial EPROM on board 1 allows the Cyclone II FPGA 16 to be booted solo, without relying on the CPLD 3, flash 5, or Stratix II FPGA 10. These two configuration methods are expected to be used during board bring-up and testing only.

### 4.3.3 Cyclone II FPGA 16 Interfaces and Pinout

### Local Bus DMA Interface (Stratix II)

Between the Stratix II FPGA 10 and the Cyclone II FPGA 16 is a DMA bus that is designed to support block data transfers from the Stratix II FPGA 10 to the Cyclone II FPGA 16 at a bandwidth that matches the x4 lane PCIe link speed. DMA events are configured in the NWL core through the CPU host, whose DMA registers are mapped into the PCI address space. DMA events occur in one direction only—from Stratix II FPGA 10 to Cyclone II FPGA 16. All DMA events are referred to as ‘DMA Reads’, taken from the perspective of the host CPU.

Below in Table 12, the DMA bus signals running between the Stratix II FPGA 10 and the Cyclone II FPGA 16 are shown. All synchronous transfers between the two FPGA's 10, 16, including those that occur over the Target Interface 19 described in the next section, are clocked by the 62.5 MHz CLKFM output clock. A CLKTM input is provided in case the DMA bus is made source-synchronous in the future.

TABLE 12
DMA Bus Signal List

| | Direction | |
|---|---|---|
| | (Relative to | |
| Signal | Cyclone II) | Description |
| DMA_CMD_RDY | Input | Asserted by user logic whenever it is ready to receive a |
| | | new TX DMA transaction. |
| DMA_CMD_EN | Output | Asserted when the DMA_CMD_BUS is valid. |
| DMA_CMD_BUS[31..0] | Output | Multiplexed command bus containing the starting |
| | | address and byte transfer length. |
| DMA_DATA_RDY | Input | Indicates when the Stratix II is ready to transfer DMA |
| | | data to the Cyclone. |
| DMA_DATA_START | Output | Asserted for one clock at the start of each new data |
| | | transfer. |
| DMA_DATA_EN | Output | Asserted to indicate the DMA_RD_DATA is valid. |
| DMA_RD_DATA[63..0] | Input | DMA DDR Data transferred from the Stratix II to the |
| | | Cyclone. |
| CLKFM | Output | The 62.5 MHz clock output from the Cyclone used for |
| | | all PCI-Link transfers to the Stratix. |
| CLKTM | Input | The 62.5 MHz clock input from the Stratix. Currently, |
| | | all transfers are clocked by CLKFM, and the CLKTM |
| | | signal is provided only for future flexibility. |

### Local Bus Target Interface (Stratix II FPGA 10)

In addition to the DMA bus, another interface exists between the Stratix II FPGA 10 and the Cyclone II FPGA 16 that allows standard PCI-type transactions. Unlike the DMA interface 18, the PCI target interface 19 supports transactions in either direction and is intended to allow the CPU host to write and read individual registers on the Stratix II FPGA 10. A 64-bit bidirectional data bus is used, and transfers are clocked using the 62.5 MHz CLKFM output clock from the Cyclone II FPGA 16. The Target Interface signals are shown below in Table 13.

TABLE 13
Local Bus Target Interface 19 Signal List

| | Direction | |
|---|---|---|
| | (Relative to | |
| Signal | Cyclone II) | Description |
| CLKFM | Input | 62.5 MHz synchronous transmit clock from Stratix |
| CLKTM | Output | Optional 62.5 MHz synchronous receive clock |
| TARG_RD_REQ | Output | Transmit data valid signal from Stratix |
| TARG_WR_REQ | Output | TX request-to-send flow control signal from Stratix |
| TARG_RD_EN | Input | Read Enable Signal from Cyclone signaling start of |
| | | transfer |
| TARG_WR_EN | Output | Write Enable Signal from Stratix signaling start of |
| | | transfer |
| TARG_USER_RDY | Input | TX clear-to-send flow control signal from Stratix |
| TARG_OE | Output | Output enable signal from Cyclone |
| TARG_D[63:0] | Input/Output | 64-bit bidirectional data bus |
| TARG_BE[7:0] | Input/Output | Byte Enables for Data Bus |

### PIPE Interface to GL9714 PHY 17

The Cyclone II FPGA 16− GL9714 bus is a single data rate (SDR) 250 MHz parallel bus, consisting of four 8-bit data channels in each direction for a total of 64 single ended signals. Clocking for both directions of the bus is derived from a 250 MHz PCLK output from the PHY 17 as described above. The PCLK signal is fed to a PLL, from which two clock signals are generated, with their respective phases adjusted to the required timing parameters of the TX and RX buses. The total signal count is approximately 120 signals, which have been assigned to I/O Banks 7 & 8 on the Cyclone II FPGA 16. Table 14 shows the signal interface between the FPGA 16 and the PHY 17.

TABLE 14
Cyclone II - GL9714 Device 17PIPE Interface Signals

| | Direction | |
|---|---|---|
| | (Relative to | |
| Signal | Cyclone II) | Description |
| PCLK | Input | 250 MHz PCLK clock signal |
| RST_N | Output | Reset signal to PHY |
| RXDA[7:0] | Input | Receiver data bus A |
| RXDB[7:0] | Input | Receiver data bus B |
| RXDC[7:0] | Input | Receiver data bus C |
| RXDD[7:0] | Input | Receiver data bus D |
| RXDK[A.D] | Input | K-code indication for the |
| | | received symbols |
| RX_IDLE[A.D] | Input | Indicates receiver detection of |
| | | an idle condition |
| RXSTSA[2:0] | Input | Receiver status signals. |
| RXSTSB[2:0] | Input | Receiver status signals. |
| RXSTSC[2:0] | Input | Receiver status signals. |
| RXSTSD[2:0] | Input | Receiver status signals. |
| TXDA[7:0] | Output | Output data bus A |
| TXDB[7:0] | Output | Output data bus B |
| TXDC[7:0] | Output | Output data bus C |
| TXDD[7:0] | Output | Output data bus D |
| TXDK[A.D] | Output | K-code indication for the |
| | | transmitted symbols |
| PHYSTS | Input | PHY status signal |
| RXVLD[A.D] | Input | Indicates valid data on Receiver |
| TXCMP[A.D] | Output | Sets the running disparity to negative |
| Other Control | Output | Miscellaneous control signals to PHY. |
| Signals | | Sets power modes, differential signal |
| | | polarity, loopback. |
| SMC | Bidir | SMBus Clock |
| SMD | Bidir | SMBus Data signal |

### 4.3.4 Debug Utilities

Status signals from the NWL core and other spare signals are brought out to testpoints and breakout headers for board 1 bring-up and testing. Note that the amount of debug headers available on the board 1 is largely dependent on the “free” board 1 space left over after all of the critical parts have been placed. Furthermore, the Stratix II FPGA 10 has priority in the allocation of debug headers, and thus the amount of debug access points available for the Cyclone II FPGA 16 may be less than desirable should board 1 real estate become a challenge.

### 4.4 CPLD 3 and Flash 5

A MAX II non-volatile CPLD 3 and parallel NOR flash 5 combination performs the configuration functions on the board 1 for the two FPGAs 10, 16. An Altera IP Flash Loader Megafunction is instantiated in the CPLD 3 and configures the two FPGAs 10, 16 from flash 5 once the CPLD 3 has been given a signal from the MMC 9 indicating that all of the board 1 power supplies have ramped up and are stable.

A MAX II EPM1270 CPLD 3 is preferably used as the configuration controller. It contains 980 equivalent macrocells and 116 user I/O's in a 144-pin TQFP package. The flash 5 is preferably a Spansion S29GL256, with a 32 MB capacity and an 8-bit or 16-bit configurable data bus width.

### 4.4.1 CPLD 3 Clocking

A 40 MHz clock provides the CPLD 3 with its single global clock domain. The CPLD 3 uses the input clock to generate the configuration DCLK frequency, which in Passive Serial mode, is equal to the 40 MHz input clock.

### 4.4.2 CPLD 3 Interfaces

### FPGA 10, 16 Configuration Bus (Passive Serial)

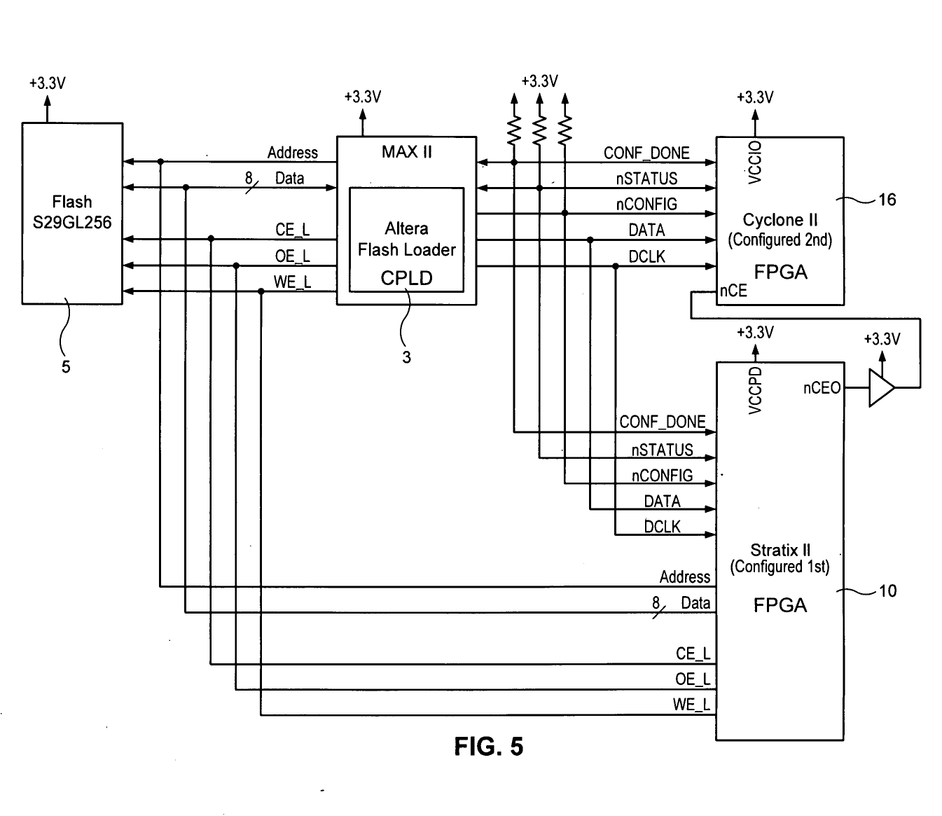

Shown in FIG. 5 is the Passive Serial configuration chain controlled by the MAX II CPLD 3. The Stratix II FPGA 10 is configured first and the Cyclone II FPGA 16 is configured second. Data is read by the CPLD 3 from flash 5 in bytes and converted to a passive serial bitstream clocked by DCLK into the FPGAs 10, 16. Note that the Stratix II FPGA 10 can power its configuration pin input buffers using a separate supply rail (VCCPD) rather than using their respective I/O bank supplies, allowing the configuration pins to operate at voltage levels that are different than the VCCIO of their banks. Therefore, even though the I/O banks in which the Stratix II FPGA 10 configuration signals are located operate at 1.8V, we can apply 3.3V to the VCCPD rail and maintain a 3.3V logic level throughout the configuration chain. This applies to the JTAG chain as well, discussed in Section 4.6. VCCPD affects only the input configuration pin; the configuration outputs are driven at the VCCIO levels associated with their respective banks. However, the number of affected outputs amounts to only two signals (nCEO and JTAG signal TDO), and we use small logic level shifting buffers to bring these two outputs up to 3.3V.

### 4.5 System Management Controller (MMC) 9

The AMC.0 specification defines a system management scheme to coordinate module management functions with the Carrier Board, and in turn, the chassis shelf manager. Module management controller (MMC) 9 on the AMC board 1 handles all management functions and communicates with the Carrier Board host manager using a messaging scheme called IMPI. Its basic functions include: module identification reporting to the host, module power requirements reporting to the host, link type negotiations with the Carrier Board, control faceplate 20 status LEDs, hot swap insertion management, and system health monitoring and reporting to the host, including temperature sensing and voltage monitoring.

Off-the-shelf firmware for the MMC 9 can be acquired from CorEdge. A Renesas H8/300H Tiny (part no. HD64F3694FY) is suitable for device 9. The H8/300H is a 16-bit microcontroller with a wide variety of on-chip peripherals, including flash, EEPROM, A/D converters, and a variety of serial ports. The H8/300H makes for a cost effective solution. A 44-pin TQFP package is used on the board 1.

The MMC 9 is powered from a separate +3.3V power rail from the AMC edge connector 12. Thus, there are two power domains defined on the board 1: a “Management Power Domain” and a “Payload Power Domain”, as defined in the AMC.0 Specification.

### 4.5.1 Booting

Program code for the H8 MMC 9 is stored in internal flash and is downloaded to the device 9 over a serial interface. The program code is delivered from CorEdge in bitstream format. However, there is an external SEEPROM on the board that contains custom parameters for the AMC board 1, such as link descriptors and board 1 power requirements. MMC 9 sends these parameters to the host during module initialization.

### 4.5.2 MMC 9 External Interfaces

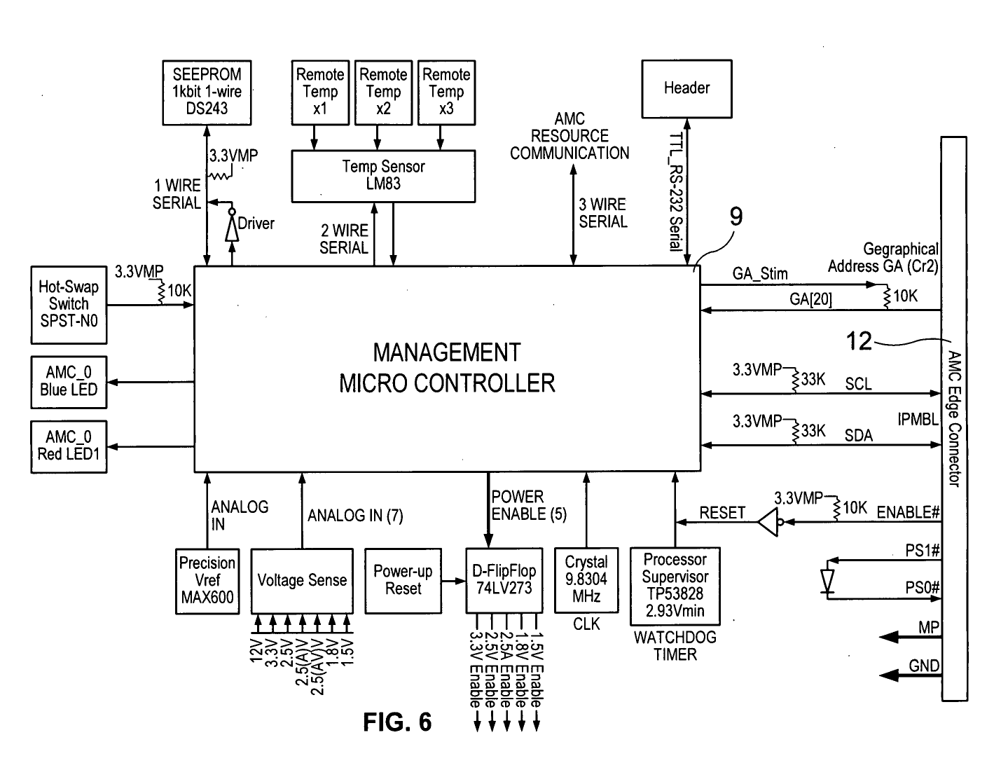

Shown in FIG. 6 is the MMC 9 system interconnect block diagram, taken from the MMC 9 datasheet released by CorEdge.

The main MMC 9 interfaces are described below.

### AMC Edge Connector 12 Specification

The AMC.0 Specification defines a set of system management signals present on the AMC edge connector 12. These signals are listed below in Table 15 and can also be found in the AMC connector pinout in Section 3.1.

TABLE 15
MMC Signals on AMC Edge Connector 12

| | AMC.0 | | |
|---|---|---|---|
| Signal Net Name | Signal Name | Driven By | Description |
| AMC_PS1_L | PS1# | AMC | Presence 1 - Used to indicate to the host that the |
| | | | AMC board is fully inserted (not connected to MMC). |
| +3P3V_MP | MP | Carrier | Management +3.3 V Power rail. Supplies up to |
| | | | 100 mA. |
| AMC_GA0 | GA0 | Carrier | Geographic Addr. 0 - assigns the module (AMC Bay) |
| | | | address to the card. |
| AMC_GA1 | GA1 | Carrier | Geographic Addr. 1 - assigns the module (AMC Bay) |
| | | | address to the card. |
| AMC_GA2 | GA2 | Carrier | Geographic Addr2 - assigns the module (AMC Bay) |
| | | | address to the card. |
| AMC_ENABLE_L | ENABLE# | Carrier | AMC Enable - reset signal for the MMC. The IPMC |
| | | | holds the MMC in reset until this signal is driven high |
| | | | by the IPMC. |
| AMC_SCL_L | SCL_L | IPMI_Agent | IPMB-L Clock - IPMI interface signal |
| AMC_SDA_L | SDA_L | IPMI_Agent | IPMB-L Data - IPMI interface signal |
| AMC_PS0_L | PS0# | Carrier | Presence 0 - Used to indicate to the host that the |
| | | | AMC board is fully inserted (not connected to MMC). |

### Payload Domain Power Control

Once the MMC 9 has negotiated an AMC link with the host, it will proceed to activate the Payload domain power rails described in Section 6.0. MMC 9 also monitors the rails using its A/D converter and reports out-of-spec conditions.

### Temperature Sensors

MMC 9 has access to three temperature sensors through a 2-wire serial interface. The AMC.0 Specification states that the “module shall provide a sensor monitoring the temperature of the component which is considered to be of most thermal concern”. The sensors on AMC board 1 monitor the temperature of the Stratix II FPGA 10, the GL9714 interface 17, and the IXF18105 interface 11.

### AMC LEDs

One or more LEDs may be mounted on the PCB such that they may be viewed through the front faceplate 20. These LEDs are used to convey hot-swap status and error conditions to the user, and are controlled by the MMC 9. The LEDs reside in the Management Power Domain.

Control Signals to/from Stratix II FPGA 10

A communications link between MMC 9 and the Stratix II FPGA 10 is provided using a 3-wire serial interface. A software protocol for this link can be defined.

### 4.5.3 Debug Utilities

A UART interface from MMC 9 to a breakout header 21 allows debug information to be output to a PC Serial Port.

### 4.6 JTAG Chain Implementation

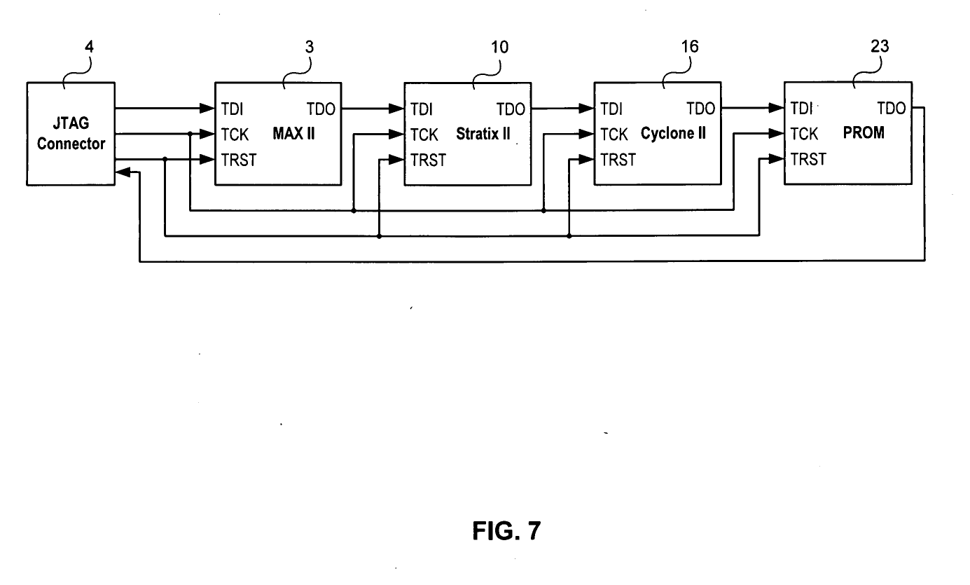

A JTAG chain used to load the devices with initial code is implemented on the AMC board 1 as shown in FIG. 7. All logic levels in the chain are 3.3V. Each device in the chain may be targeted individually as well by setting 0 Ohm jumper options or DIP switches. This allows for the case in which one of the devices in the chain is malfunctioning, causing a break in the chain.

MMC 9 has a JTAG interface as well that is brought out to a separate connector and is not a part of the above FPGA chain. MMC 9 is powered in a different power domain than the rest of the board 1, and therefore requires its own JTAG interface.

### 5.0 SIGNAL INTEGRITY DISCUSSIONS

Signal Integrity analysis was done on the high-speed interfaces using HyperLynx LineSim 7.7 in order to investigate appropriate termination schemes and to verify the integrity of the various high-speed topologies. Of particular concern was the elimination of the QDRII 6 termination resistor packs on all data lines (the r-packs were removed in order to effectively route the board 1 in 16 layers). Another area of concern was the dual-DIMM topology for the DDR2 SDRAM 7, which had to be carefully modeled in order to determine the best ODT settings for the DIMMs 7.

### 6.0 POWER SUPPLIES

The AMC board's Payload Power circuit derives all of its required rails from a 80 W 12V source which is brought into the AMC board 1 via the AMC edge connector 12. As the board 1 outline is defined by the AMC.0 Specification, the amount of real estate occupied by the power supply must be minimized in order to support the placement of other components. Digital circuits demand more power as the speed and number of active logic elements increase, so in order to optimize the performance of the AMC board 1, an efficient power supply is also required. A maximum of 80 W is available, as defined by the AMC.0 Specification.

The AMC board 1 Payload Power domain is comprised of seven digital and analog voltage supplies: 1.2V Digital, 1.2V Analog, 1.8V Digital, 1.8V Analog, 2.5V Digital, 2.5V Analog, and 3.3V Digital. The digital supplies power the core and IO voltages of the digital sections of the board 1 ICs, while the analog supplies provide power for the PLLs and other sensitive analog sections. The analog supplies have lower noise and tighter regulation in comparison to the digital supplies.

### 6.1 Power Budget

An overview of the power supply requirements is illustrated by Table 16. This summary assumes an overall device usage of 90% for the Stratix II FPGA 10, 50% for the Cyclone II FPGA 16, 80% for the DDR2 DIMM 7, and 80% for the QDRII SDRAM 6. It also assumes that the operating frequencies will be 320 MHz for the Stratix II FPGA 10, 75 MHz for the Cyclone II FPGA 16, 320 MHz for the DDR2 DIMM 7, and 300 MHz for the QDRII SDRAM 6.

TABLE 16
Power Supply Summary

| Power Rail | Stratix II | Cyclone II | DDR2 | QDRII | GigE Phy | PCIe Phy | Misc | Total (mW) |
|---|---|---|---|---|---|---|---|---|
| +3.3 VD | 250 | 50 | | | 600 | | 450 | 1,350 |
| +2.5 VA | 950 | | | | 750 | | | 1,700 |
| +2.5 VD | 200 | 1,600 | | | 2,000 | 500 | 150 | 4,450 |
| +1.8 VA | | | | | 600 | 600 | | 1,200 |
| +1.8 VD | 6,000 | | 12,000 | 4,500 | 2,400 | 300 | | 25,200 |
| +1.2 VA | 120 | | | | | | | 120 |
| +1.2 VD | 25,000 | 800 | | | | | | 25,800 |
| Total | | | | | | | | 59,820 |

### 6.2 Power Supply Specifications

### 6.2.1 Output Voltages and Currents

The power supply output voltages, voltage tolerance, currents, ripple, power, and efficiency are listed in Table 17 below. By meeting the minimum efficiency targets of Table 17, the overall efficiency of the AMC Power Supply is 86%.

TABLE 17
Power Supply Operating Specifications

| | | Nominal | P-P | Minimum |
|---|---|---|---|---|
| Power Rail | Tolerance | Current | Ripple | Efficiency |
| (V) | (%) | (mA) | (mV) | (%) |
| +3.3 V Digital | ±5 | 415 | 82 | 85 |
| +2.5 V Analog | ±5 | 680 | 25 | n/a (LDO) |
| +2.5 V Digital | ±5 | 1,780 | 62 | 85 |
| +1.8 V Analog | ±5 | 670 | 18 | n/a (LDO) |
| +1.8 V Digital | ±5 | 14,000 | 45 | 90 |
| +1.2 V Digital | ±4 | 21,500 | 30 | 85 |
| +1.2 V Analog | ±4 | 100 | 15 | n/a (LDO) |

### 6.2.2 Regulation

The power supply line and load regulations, and load transient response requirements, are outlined in Table 18 below.

TABLE 18
Regulation Specifications

| | Load | Line | 50% Load Transient | Output |
|---|---|---|---|---|
| Power Rail | Regulation | Regulation | Maximum | Recovery |
| (V) | (mV/V) | (mV/A) | Deviation (mV) | Time (μs) |
| +3.3 V Digital | 10 | 18 | 83 | 100 |
| +2.5 V Analog | 3 | 6 | 25 | 100 |
| +2.5 V Digital | 15 | 31 | 62 | 100 |
| +1.8 V Analog | 4.5 | 9 | 18 | 100 |
| +1.8 V Digital | 11 | 1 | 45 | 100 |
| +1.2 V Digital | 7.5 | 0.7 | 30 | 100 |
| +1.2 V Analog | 3 | 0.3 | 15 | 100 |

### 6.3 Power Supply Topology

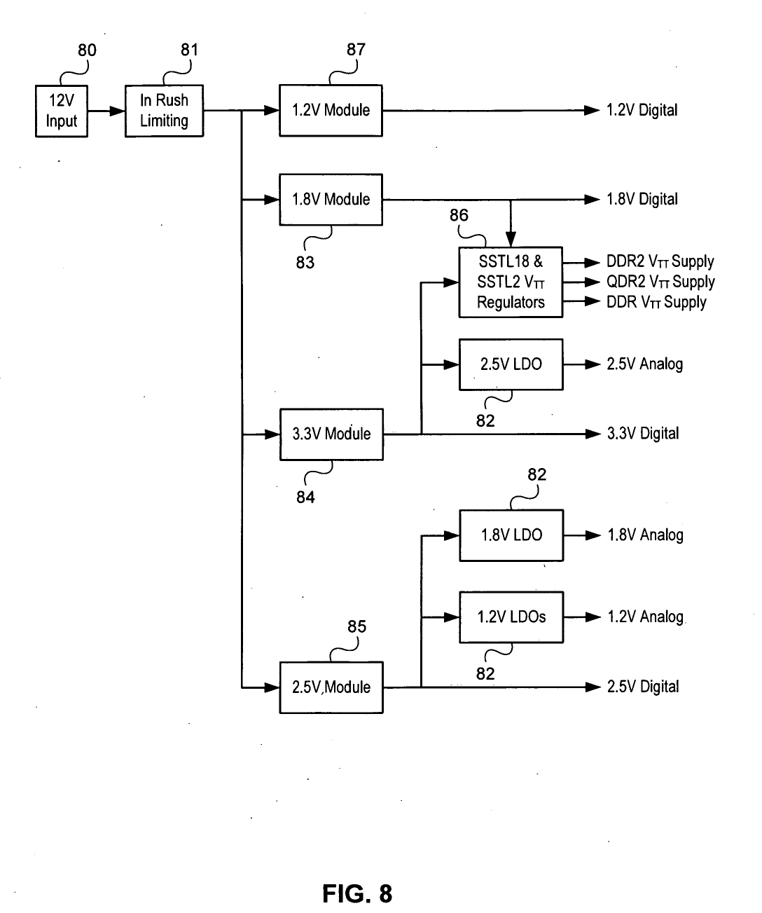

The power supply topology for the Payload Power Domain is illustrated in FIG. 8. A modular approach is used in order to optimize for board space, efficiency, and ease of development.

Each of the digital supplies is derived directly from the main 12V supply 80 to maximize the overall efficiency and to minimize the required board 1 space. Cascading supplies can lead to a lower overall efficiency, as power losses accumulate across multiple stages. However, a cascaded supply can provide better parts costs, as simpler modules may be chosen.

LDO (Linear Drop Out) regulators 82 are used to generate the sensitive analog supply voltages, as these types of regulators provide superior noise performance over their SMPS (Switched Mode Power Supply) counterparts. LDO regulators do suffer from lower efficiencies, but these losses do not significantly affect the overall efficiency, as the 1.8V and 2.5V Analog supplies draw lower power.

The DDR2, QDRII, and DDR V_{TT} are each designed to source or sink upwards of 2 A, and as these are not switching supplies, the 1.8V module 83 is required to source upwards of 20 A and provide upwards of 36 W of power. Likewise, as the 3.3V and 2.5V modules 84, 85 supply the 2.5V, 1.8V, and 1.2V LDO, these modules must also supply the current required by these regulators, so the total current load on the 3.3V and 2.5 modules is 1.2 A and 2.6 A, respectively.

Assuming the minimum efficiencies as given in Table 19, the total load on the 12V supply is 82.5 W. While this load exceeds the requirements of the AMC.0 Specification, it is important to note that the calculation uses the peak load of the V_{TT} supplies, which will rarely occur in the actual operation. Should the V_{TT} supplies use as much as 50% of the available power, the net power load on the 12V supply will drop to 76 W.

### 6.3.1 In-Rush Current Limiting Circuit 81

The AMC 2.0 Specification calls for a maximum input capacitance on the 12V line of 800 μF and also specifies that the host system must shut down the 12V supply to an AMC card once the load current reaches a trip level of 9.1 A. An in-rush current limiting circuit 81 is included in the power supply design, to prevent the turn-on in rush current from triggering an overcurrent condition. This circuit limiter 81 simply consists of a P channel power MOSFET whose turn-on time is controlled by a RC charging circuit once the 12V power is applied to the system. The advantage of this method is that it is simple, low cost, easily tuned, and independent of the turn-on slew rate.

### 6.3.2 1.2V Module 87

The 1.2V Digital supply 87 must provide upwards of 22 A to the AMC board 1 and be able to generate this supply 8 from 12V input at a high efficiency. This supply 87 must also be able to maintain a 1.2V output voltage within ±4% over a load range of 5 A to 22 A as the performance demands on the system vary.

A PTH08T210W module from TI can be used to meet the requirements of this supply 87. This module 87 can provide upwards of 30 A and is 87% efficient at a load of 26 A. The module size is 1.37×0.62 inches, and is available at a 1K volume cost of $18.00. It regulates the output voltage within ±1.5% over its full temperature, input voltage, and load current range. By placing an appropriate pull-down resistor on the module's Inhibit/UVLO pin, the module 87 can be programmed to turn on only when the input supply voltage has reached 9.5V. Setting the turn-on voltage to this point helps to avoid in-rush current problems. With a high quality output capacitance of 4000 μF, the transient response of this TI module 87 is specified for 40 mV voltage over-and-undershoot for a load step of 50% (15 A) at a 2.5 A/μs slew rate with a 50 μs recovery time.

### 6.3.3 1.8V Module 83

The 1.8V Digital supply 83 must provide upwards of 20 A to the AMC board 1 and be able to generate this supply from 12V input at a high efficiency. 14 A is required to supply the general electronics, while an additional 6 A is required to power the SSTL2 and SSTL18 V_{TT} supplies 86. This supply 83 must also be able to maintain a 1.8V output voltage within ±5% over a load range of 3 A to 20 A as the performance demands on the system vary.

To provide the 1.8V Digital supply 83, a PTH08T210W module from TI can be used to meet the system requirements. This module 83 can source up to 30 A and is 89% efficient at loads from 10 A to 25 A. The module 83 size is 1.37×0.62 inches, and is available at a 1K volume cost of $18.00. It regulates the output voltage within ±1.5% over its full temperature, input voltage, and load current range. By placing an appropriate pull-down resistor on the module's Inhibit/UVLO pin, the module 83 can be programmed to turn on only when the input supply voltage has reached 9.5V. Setting the turn-on voltage to this point helps to avoid in-rush current problems. With a high quality output capacitance of 1360 μF, the transient response of the TI module 83 is specified for 35 mV voltage over-and-undershoot for a load step of 25% (7.5 A) at a 2.5 A/μs slew rate with a 50 μs recovery time.

### 6.3.4 2.5V Module 85

The 2.5V Digital supply 85 must provide upwards of 2.5 A to the AMC board 1 and be able to generate this supply from 12V input at a high efficiency. This module also supplies the 1.8V Analog and 1.2V Analog LDO regulators 82. This supply 85 must also be able to maintain a 2.5V output voltage within ±5% over a load range of 0.5 A to 2.5 A as the performance demands on the system vary.

To provide the 2.5V Digital supply 85, a PTH08T260W module from TI can be used to meet the system requirements. This module 85 can source up to 3 A and is 86% efficient at a load of 2 A. The module size is 0.745×0.62 inches, and is available at a 1K volume cost of $6.25. It regulates the output voltage within ±1.5% over its full temperature, input voltage, and load current range. By placing an appropriate pull-down resistor on the module's Inhibit/UVLO pin, the module 85 can be programmed to turn on only when the input supply voltage has reached 9.5V. Setting the turn-on voltage to this point helps to avoid in-rush current problems. With a high quality output capacitance of 680 μF, the transient response of the TI module 85 is specified for 13 mV voltage over-and-undershoot for a load step of 25% (1.5 A) at a 2.5 A/μs slew rate with a 70 μs recovery time.

### 6.3.5 3.3V Module 84

The 3.3V Digital supply 84 must provide upwards of 1.2 A to the AMC board 1 and be able to generate this supply from 12V input at a high efficiency. This module 84 will also supply power to the 2.5V Analog LDO regulator 82 and digital power to the SSTL18/SSTL2 V_{TT} regulators 86. This supply 84 must also be able to maintain a 3.3V output voltage within ±5% over a load range of 0.1 A to 1.2 A as the performance demands on the system vary.

To provide the 3.3V Digital supply 84, a PTH08T260W module from TI can be used to meet the system requirements. This module 84 can source up to 1 A and is 84% efficient at a load of 2 A. The module size is 0.745×0.62 inches, and is available at a 1K volume cost of $6.25. It regulates the output voltage within ±1.5% over its full temperature, input voltage, and load current range. By placing an appropriate pull-down resistor on the module's Inhibit/UVLO pin, the module 84 can be programmed to turn on only when the input supply voltage has reached 9.5V. Setting the turn-on voltage to this point helps to avoid in-rush current problems. With a high quality output capacitance of 330 μF, the transient response of the TI module 84 is specified for 18 mV voltage over-and-undershoot for a load step of 25% (1.5 A) at a 2.5 A/μs slew rate with a 70 μs recovery time.

### 6.3.6 DDR, DDR2, QDRII V_{TT} Termination Regulators 86

A specific regulator 86 for the DDR2, QDRII, and DDR V_{TT} termination voltage is required, as the supply must be able to accurately track the midpoint of the SDRAM 7 VDDQ supply while also providing a fast transient response to support the high-speed switching of the DDR2, QDRII, and DDR busses. Since DDR 7 and QDRII 6 both use a SSTL18 signaling, it is possible to share a V_{TT} supply between these two memory segments. However, as they are placed in different parts of the board 1, two individual supplies are used to ensure that the transient response to any supply is not compromised by the power supply placement. DDR 7 uses a SSTL2 signaling, and so a dedicated regulator 86 is required for this V_{TT} supply.

To power the individual V_{TT} supplies, a MIC5162 drop out controller 86 is used. This part is JEDEC complaint for SSTL, HSTL, and DDR memory applications, and features sourcing and sinking capabilities. It also operates from a V_{cc} supply 84 of 3.3V, eliminating the need for a separate 5V boost as will be necessary for many other comparable parts.

The MIC5162 86 is only a controller, and so external MOSFETs must also be selected to match the controller 86 capabilities and the power requirements of the V_{TT} supplies. With a 3.3V supply voltage, the low threshold MOSFETs must be chosen to ensure that the controller 86 has sufficient headroom to turn on the high-side FETs. To meet this requirement, the N channel S15920 1.5V_{GS} is used.

### 6.3.7 Analog Voltage Supplies 82

Three analog voltage supplies 82, a 1.2V analog, 1.8V analog, and a 2.5V analog, are required by the components on the board 1. Each analog supply 82 is derived by an LDO regulator to provide a precise and low noise voltage supply. In order to optimize the efficiency of these LDO regulators 82, the input supplies are selected to be as close to the output voltage as possible.

A 1.2V analog supply 82 is derived by a TI SN105125 150 mA LDO regulator. In total, the 1.2V analog supply 82 draws 100 mA, but as two different parts require a precise and clean 1.2V supply, two separate 1.2V analog supplies are used. Both derive their voltage supply from the 2.5V supply 85 as opposed to the 1.8V supply, as the 2.5V supply 85 has less digital noise. This SN105125 82 has a dropout voltage of 1V, so there is sufficient headroom for this part to operate.

The 1.8V analog supply 82 is derived by a Linear LT1963 1.5 A LDO regulator, with the 2.5V digital supply acting as the power source for the 1.8V analog supply 82. This regulator 82 has a dropout voltage of 340 mV, so there is sufficient headroom for this part to function off the 2.5V supply 85.

The 2.5V analog supply 82 is derived by a TI TPS79625 1A LDO regulator, with the 3.3V digital supply 84 acting as the power source for the 2.5V analog supply 82. The TP79625 82 has a dropout voltage of 365 mV, so there is sufficient headroom for this part to function off a 3.3V supply.

### 6.4 Power Supply Sequencing

The Altera Cyclone II FPGA 16 and Stratix II FPGA 10 devices 10, 16 support any power supply sequencing, and require only that the supplies ramp monotonically within 100 μs to 100 ms. As well, both the Intel IXF18105 10 GigE Phy 11 and the Genesys Logic GL9714 PCIe Phy 17 do not require any specific power supply sequencing.

The QDRII and DDR devices 6, 7 require that the V_{DD} supply sequence before or at the same time as the V_{DDQ} supply, while the V_{DDQ} must sequence before or at the same time as V_{ref}. V_{DD} and V_{DDQ} are both supplied by the 1.8V Digital supply 83, while the V_{ref} voltage is derived from the 1.8V supply 83 and generated by the DDR2 V_{TT} termination regulator 86.

### 7.0 LAYOUT

TABLE 19
PCB Information

| Board Criteria | Description |
|---|---|
| PCB name | AMC board |
| PCB fab number and rev | 022-GV0101-001 |
| PCB assy number and rev | 021-GV0101-001 |
| PCB fab vendor name | Streamline Circuits |
| Estimated pin count | 7115 pins |
| Schematic capture tool | DxDesigner/CES |
| Layers count | 16 |
| PCB target impedance | 50 Ohm/100 Ohm diff pair |
| Tented vias | Component Side 1 only |
| Minimum trace width | 3.1 mils |
| Minimum via drill size | 10 mils |
| Test Points | 89 test points, SMT |
| Place (ICs and discretes): | 1166 |

### 8.0 MECHANICAL CONSIDERATIONS

The AMC board 1 is designed according to the mechanical requirements listed in the AMC.0 Specification. The board is Double-width, Full-height, Single-Layer, with a type B+ Extended Edge Connector. The B+ connector is dual-sided, with a total of 170 pins.

The maximum component height on the primary side is 22.45 mm, and the total height span across both sides of the PCB is 26.62 mm. The PCB has a thickness of 1.6 mm +/−10%. Heat sinks may be required for the Stratix II FPGA 10, Cyclone II FPGA 16, GL9714 interface 17, and IXF18105 interface 11, along with a forced-air cooling airflow of 1.0 m/sec. A thermal and cooling management strategy can be developed with the chassis manufacturer to ensure safe operation of the AMC board 1 over the operating ambient temperature range.

### 9.0 CONCLUSION

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. Telecommunications computing apparatus comprising:
a reconfigurable logic device;
coupled to the reconfigurable logic device, means for coupling the reconfigurable logic device to an external digital network; and
coupled to the reconfigurable logic device, an interface for coupling the reconfigurable logic device to at least one peripheral device that is not part of said external digital network.

2. The apparatus of claim 1 wherein the reconfigurable logic device comprises an FPGA.

3. The apparatus of claim 1 wherein the interface comprises at least one PCI Express connector.

4. The apparatus of claim 1 wherein the interface comprises at least one FPGA.

5. The apparatus of claim 1 wherein the interface comprises at least one DMA (Direct Memory Access) component and at least one PCI target interface component.

6. The apparatus of claim 1 wherein the coupling means comprises:
a physical coupling device connected to the reconfigurable logic device;
an edge connector connected to the physical coupling device;
a backplane connected to the edge connector; and
at least one line card connected to the backplane.

7. The apparatus of claim 1 further comprising a backplane, wherein each said peripheral device is connected to the backplane.

8. The apparatus of claim 1 wherein said apparatus consists solely of application-specific and reconfigurable hardware elements.

9. The apparatus of claim 1 wherein said reconfigurable logic device performs the following functions:
reassembly of TCP data by solely hardware means, wherein the TCP data emanates from the external digital network;
search for known patterns within the reassembled TCP data; and
policy management decisions made with respect to patterns found within the reassembled TCP data.

10. The apparatus of claim 1 when the external digital network is a network from the group of networks consisting of at least one of the Internet, a wireless network, a wired network, a local area network (LAN), a wide area network (WAN), and the public switched telephone network (PSTN).

11. The apparatus of claim 1 wherein the reconfigurable logic device performs deep packet inspection on data packets emanating from the external digital network.

12. The apparatus of claim 1 wherein the reconfigurable logic device performs at least one function from the following group of functions:
flow control of network traffic on the external digital network;
traffic analysis and management of network traffic on the external digital network;
bandwidth shaping;
advanced routing applications.

13. The apparatus of claim 1 wherein said apparatus is part of a system for controlling transmission of data packets through the external digital network, each data packet comprising a payload portion, the external digital network comprising a plurality of network-capable devices communicatively coupled to a network access point (NAP), said system comprising:
the apparatus of claim 1, wherein said apparatus contains content match information and is operable to:
inspect payload portions of data packets transiting the NAP;
forward an inspected data packet when information within the payload portion of an inspected data packet is not substantially similar to content match information; and
when information within the payload portion of an inspected data packet is substantially similar to content match information, temporarily store the inspected data packet, and send a message to a network-capable device.

14. A method for inspecting payload portions of data packets transiting a network access point (NAP), wherein:
the NAP is part of the external digital network of claim 1; and
the reconfigurable logic device of claim 1:
further comprises a backplane, each peripheral device being connected to the backplane;
forwards reassembled payload portions of data packets, as well as metadata used to identify TCP connections corresponding to the packets, to relevant peripheral devices;
allows an inspected data packet to traverse the network when information within a payload portion of an inspected data packet is not substantially similar to prestored content match information; and
when information within a payload portion of an inspected data packet is substantially similar to prestored content match information, performs at least one of the following four steps:
reports the match to at least one peripheral device;
prevents the packet from further traversing the network;
allows subsequent packets from the corresponding TCP connection to pass through the reconfigurable logic device undisputed;
attempts to forcibly terminate the corresponding TCP connection.

15. The apparatus of claim 1 further comprising at least one bank of SDRAM (Synchronous Dynamic Random Access Memory) memory coupled to the reconfigurable logic device.

16. The apparatus of claim 1 further comprising at least one bank of SRAM (Static Random Access Memory) coupled to the reconfigurable logic device.

17. The apparatus of claim 1 wherein the apparatus complies with the AdvancedMC Standard.

18. The apparatus of claim 1 further comprising an intelligent microcontroller coupled to said reconfigurable logic device, said microcontroller adapted to manage power consumption of elements of the apparatus, and to perform other control functions pursuant to the AdvancedMC Standard.

19. The apparatus of claim 1 wherein the reconfigurable logic device is reprogrammed by a technique from the group of techniques consisting of: loading the reconfigurable logic device via a flash memory coupled to the reconfigurable logic device, reprogramming via installed JTAG headers coupled to the reconfigurable logic device, and reprogramming via JTAG headers provided on a backplane to which the reconfigurable logic device is coupled.

20. Apparatus comprising:
telecommunications computing architecture elements compliant with the AdvancedMC Standard;
coupled to said elements, means for communicating with an external digital network; and
coupled to said elements, means for interfacing with at least one peripheral device that is not part of said external digital network.

21. The apparatus of claim 20 wherein said interfacing means comprises at lest one PCI Express connector.

22. Telecommunications computing apparatus compliant with the AdvancedMC Standard, said apparatus comprising:
a reconfigurable logic device; and
coupled to the reconfigurable logic device, an interface for coupling the reconfigurable logic device to an external digital network; wherein
the reconfigurable logic device performs deep packet inspection of data packets entering the reconfigurable logic device from the external digital network.

23. The apparatus of claim 22 wherein the reconfigurable logic device comprises an FPGA.

24. The apparatus of claim 22 wherein the deep packet inspection comprises content matching between content portions of data packets entering the reconfigurable logic device from the external digital network and prestored content templates accessible to the reconfigurable logic device.
